(19) United States
(12) Patent Application Publication
(10) Pub. No.: US 2018/0324497 A1
(43) Pub. Date: Nov. 8, 2018

(54) SYSTEMS AND METHODS FOR BROWSING CONTENT STORED IN THE VIEWER'S VIDEO LIBRARY

(71) Applicant: Rovi Guides, Inc., San Jose, CA (US)

(72) Inventor: Thomas Steven Woods, Arlington Heights, IL (US)

(21) Appl. No.: 15/977,845

(22) Filed: May 11, 2018

Related U.S. Application Data
(63) Continuation of application No. 13/793,147, filed on Mar. 11, 2013, now abandoned.

(51) Int. Cl. H04N 21/472; H04N 21/433; G11B 27/10; H04N 21/2668; H04N 21/258

(52) U.S. Cl. CPC H04N 21/47202; H04N 21/4333; H04N 21/4331; H04N 21/2668; H04N 21/25891; G11B 27/10

(57) ABSTRACT

Systems and methods are described for presenting recorded media assets on user equipment. In some aspects, the systems and methods described determine that a reference event has occurred. In response to the determination, the systems and methods search a plurality of media assets stored on a storage device for a media asset that matches a user profile. Control circuitry measures an amount of time that has elapsed from a time at which the reference event occurred until an input requesting display of the media asset is received. The control circuitry receives the input. In response to receiving the input, the control circuitry retrieves the media asset from the storage device and causes the media asset to be presented on the user equipment starting from a play position that is offset from a beginning of the media asset by the measured amount of time.

### BACKGROUND

Traditional electronic program guides require viewers to locate a suitable content to watch by browsing channels, scanning an electronic program guide grid, or by searching for content in the electronic program guide. However, viewers often desire to locate content that they are interested in with less effort than that required by current traditional electronic program guides. Viewers will watch any content that they believe they will enjoy, even though the content may already have begun broadcasting. To minimize search efforts, viewers often watch content that they own. Viewers choose to watch previously owned content since they know that they enjoyed the content enough to purchase it. However, traditional systems fail to provide an efficient and seamless way to integrate content that the viewer already owns along with conventional broadcast programming in an interactive electronic program guide.

### SUMMARY

In view of the foregoing, the systems and methods described herein provide an efficient and seamless mechanism for a user to discover media content that he owns while channel surfing through an interactive media guidance application. The interactive media guidance application may include listings for content that the user already owns or has access to. The interactive media guide may include one or more on-demand channels that can access on-demand media assets that the user previously owns.

For example, the systems and methods described may search for on-demand media assets from various media sources that the user has access to. In some embodiments, on-demand media assets that the user may be interested in may be identified by examining user viewing preferences set in the user's profile. Once an on-demand media asset is identified, the media guidance application may generate an on-demand channel and a media asset listing for that identified on-demand media asset. In some embodiments, the on-demand media asset channel may be inserted at a channel location based on the amount of time required to buffer the on-demand media asset once it is received. In some embodiments, the systems and methods may track the viewing history of the on-demand media assets accessed at the user equipment to select media assets that have not been viewed at the user equipment for a predetermined amount of time. In some embodiments, user selection of an on-demand media asset listing from the media guidance application may initiate display of the on-demand media asset from a playback location that is not the beginning of the media asset. This allows the user to view the on-demand media asset as if it was a broadcast media program being received on a conventional broadcast channel.

The systems and methods described may determine whether a first on-demand media asset is accessible to a user and matches a user profile associated with the user. The first on-demand media asset is received, without being displayed, starting from a first playback position at the user equipment without receiving user input to view the first on-demand media asset upon determining that the first on-demand media asset matches the user profile. A user input is received at the user equipment to view the first on-demand media asset at the user equipment. A second playback position of the first on-demand media asset, which is later than the first playback position, is determined.

The first on-demand media asset is presented on the user equipment starting from the determined second playback position.

In some embodiments, the systems and methods described include determining that the first on-demand demand media asset was received at the user equipment on an on-demand media asset channel. A media asset listing placed in a media listing grid is generated for the first on-demand media asset.

In some embodiments, an amount of buffer time required to access the first on-demand media asset at the user equipment is determined. A placement location is calculated for the first on-demand media asset listing in a media listing grid based on the determined buffer time. The first on-demand media asset listing is placed in the media listing grid at the calculated placement location.

In some embodiments, a user input to change the currently selected channel is received. The number of channels between the currently selected channel and the on-demand media asset channel is calculated. A threshold value is retrieved from a memory of the user equipment. The calculated number of channels is compared against the threshold value. The first on-demand media asset is buffered upon determining that the threshold value is greater than the calculated number of channels.

In some embodiments, the systems and methods determine whether a second on-demand media asset is accessible to the user and matches the user profile. The systems and methods determine whether the first on-demand media asset has been presented at the user equipment more recently than the second on-demand media asset. Upon determining that the first on-demand media asset has been presented at the user equipment more recently than the second on-demand media asset, the second on-demand media asset is received, but not displayed, starting from a first playback position at the user equipment. In another embodiment, the second on-demand media asset is received at the user equipment after the first media asset is received upon determining that the second on-demand media asset is accessible to the user and matches the user profile.

In some embodiments, a user input is received to restart playback of the first on-demand media asset from the first playback position. Playback of the first on-demand media asset is started from the first playback position.

In some embodiments, an option is presented to view the first on-demand media asset without advertisements.

In some embodiments, the systems and methods determine whether the user equipment is powered on and content is being viewed by the user at the user equipment. The first on-demand media asset is received at the user equipment upon determining that the user equipment is on and content is being viewed by the user at the user equipment.

In some embodiments, the systems and methods described determine that a reference event has occurred. In response to the determination, the systems and methods search multiple media assets stored on a storage device for a media asset that matches a user profile. Control circuitry measures an amount of time that has elapsed from a time at which the reference event occurred until an input requesting display of the media asset is received. The control circuitry receives the input. In response to receiving such an input, the control circuitry retrieves the media asset from the storage device and causes the media asset to be presented on the user equipment starting from a play position that is offset from a beginning of the media asset by the measured amount of time.

In some embodiments, determining that a reference event has occurred may include detecting that user is viewing the user equipment or detecting that the user equipment is powered on.

In some embodiments, a plurality of storage devices may be searched to identify the media asset that matches the user profile. In another embodiment, the storage devices may be located on the same wireless network as the user equipment.

In another embodiment, the identified media asset may be retrieved from the storage device once buffering is initiated.

It should be noted that the systems and/or methods described above may be applied to, or used in accordance with, other systems, methods and/or apparatuses.

### BRIEF DESCRIPTION OF THE DRAWINGS

The above and other objects and advantages of the systems and methods described herein will be apparent upon consideration of the following detailed description, taken in conjunction with the accompanying drawings, in which like reference characters refer to like parts throughout, and in which:

FIG. 1 shows an illustrative embodiment of a display screen that may be used to provide media guidance application listings and other media guidance information in accordance with various embodiments of the invention;

FIG. 2 shows another illustrative embodiment of a display screen that may be used to provide media guidance application listings in accordance with various embodiments of the invention;

FIG. 3 shows an illustrative embodiment of a user equipment device in accordance with various embodiments of the invention;

FIG. 4 shows a block diagram of an illustrative embodiment of a cross-platform interactive media system in accordance with various embodiments of the invention;

FIG. 5A is an illustrative embodiment of a block diagram of an eye tracker for identifying the gaze point of a user of user equipment in accordance with various embodiments of the invention;

FIG. 5B is another illustrative embodiment of a block diagram of a face tracker for identifying the gaze point of a user of user equipment in accordance with an embodiment in accordance with various embodiments of the invention;

FIG. 6 shows an illustrative embodiment of a display screen that may be used to provide media guidance application listings in accordance with various embodiments of the invention;

FIG. 7 shows an illustrative embodiment of a display screen displayed when a user selects an on-demand media listing from the media guidance application in accordance with an embodiment of the invention;

FIG. 8 shows another illustrative embodiment of a display screen displayed when a user selects an on-demand media listing from the media guidance application in accordance with an embodiment of the invention;

FIG. 9 shows an illustrative embodiment of a flow diagram depicting a process in which an on-demand media asset is presented on the user equipment in accordance with various embodiments of the invention;

FIG. 10 shows an illustrative embodiment of a flow diagram depicting a process in which an on-demand media asset listing is generated and in which an on-demand media asset is initiated for display in accordance with various embodiments of the invention;

FIG. 11 shows an illustrative embodiment of a flow diagram depicting a process in which an on-demand media asset is selected from a list of on-demand media assets based on the date it was last accessed in accordance with various embodiments of the invention; and

FIG. 12 shows an illustrative embodiment of a flow diagram depicting a process in which a stored media asset is presented on the user equipment in accordance with various embodiments of the invention.

### DETAILED DESCRIPTION OF EMBODIMENTS

An interactive media guidance application allows users to browse through media listings of broadcast and on-demand programming. When a user is browsing the media listings, he may be interested in watching media content that he owns and may have even previously viewed. Users are often interested in viewing previously owned content because they enjoyed the content enough to have made the purchase and they are often looking for content enjoyment with minimum effort. Users will often choose to view the content even if such a previously viewed media asset is already halfway complete. Users may be interested in finding media listings for such content in an interactive media guidance application.

To cater to such needs of a user, an interactive media guidance application may generate and include media listings for content that the user previously owns. Such content may be media content stored on a storage device, content in an online store that the user is allowed to access, or content found in a user library stored in a remote database. Such media assets that the user has previously purchased or has access to is referred to herein as a user owned on-demand media asset or a previously owned media asset.

A user equipment may stream such previously owned media assets as if the content were actual live broadcast media content. Media asset listings for such previously owned media assets being streamed to the user equipment may be integrated into the interactive media guidance application to allow the user to find such content while browsing the media guidance application. The media asset may be streamed by the server to the user equipment from a reference point. This reference point may be the time that the user equipment is powered on or when the user equipment determines that a user has begun watching its display screen. The media guidance application may allow the user to tune to such a previously owned media asset from the middle of the previously owned media asset. Allowing the user to tune to the previously owned media asset from the middle of the program allows the user to experience the previously owned media asset as if it were broadcast live.

Media listings for such previously owned assets may be generated and integrated into the interactive media guidance application. Streaming previously owned media assets may involve buffering the content until an ideal bit rate is determined. The media listings for the previously owned media assets may be placed in specific locations of a media guidance grid so that the media asset can be buffered before the user navigates to its media listing. Such a technique for intelligently placing the media listing for streaming media assets to avoid buffering the streaming media asset after the user has selected its media listing allows for a truly seamless browsing experience.

The amount of content available to users in any given content delivery system can be substantial. Consequently, many users desire a form of media guidance through an interface that allows users to efficiently navigate content selections and easily identify content that they may desire. An application that provides such guidance is referred to herein as an interactive media guidance application or, sometimes, a media guidance application or a guidance application. The context aware media control system may be implemented through such an interactive media guidance application.

Interactive media guidance applications may take various forms depending on the content for which they provide guidance. One typical type of media guidance application is an interactive television program guide. Interactive television program guides (sometimes referred to as electronic program guides) are well-known guidance applications that, among other things, allow users to navigate among and locate many types of content or media assets. Interactive media guidance applications may generate graphical user interface screens that enable a user to navigate among, locate and select content. As referred to herein, the terms “media asset” and “content” should be understood to mean an electronically consumable user asset, such as television programming, as well as pay-per-view programs, on-demand programs (as in video-on-demand (VOD) systems), Internet content (e.g., streaming content, downloadable content, Webcasts, etc.), video clips, audio, content information, pictures, rotating images, documents, playlists, websites, articles, books, electronic books, blogs, advertisements, chat sessions, social media, applications, games, and/or any other media or multimedia and/or combination of the same. Guidance applications also allow users to navigate among and locate content. As referred to herein, the term “multimedia” should be understood to mean content that utilizes at least two different content forms described above, for example, text, audio, images, video, or interactivity content forms. Content may be recorded, played, displayed or accessed by user equipment devices, but can also be part of a live performance.

With the advent of the Internet, mobile computing, and high-speed wireless networks, users are accessing media on user equipment devices on which they traditionally did not. As referred to herein, the phrase “user equipment device,” “user equipment,” “user device,” “electronic device,” “electronic equipment,” “media equipment device,” or “media device” should be understood to mean any device for accessing the content described above, such as a television, a Smart TV, a set-top box, an integrated receiver decoder (IRD) for handling satellite television, a digital storage device, a digital media receiver (DMR), a digital media adapter (DMA), a streaming media device, a DVD player, a DVD recorder, a connected DVD, a local media server, a BLU-RAY player, a BLU-RAY recorder, a personal computer (PC), a laptop computer, a tablet computer, a WebTV box, a personal computer television (PC/TV), a PC media server, a PC media center, a hand-held computer, a stationary telephone, a personal digital assistant (PDA), a mobile telephone, a portable video player, a portable music player, a portable gaming machine, a smart phone, or any other television equipment, computing equipment, or wireless device, and/or combination of the same. In some embodiments, the user equipment device may have a front facing screen and a rear facing screen, multiple front screens, or multiple angled screens. In some embodiments, the user equipment device may have a front facing camera and/or a rear facing camera. On these user equipment devices, users may be able to navigate among and locate the same content available through a television. Consequently, media guidance may be available on these devices, as well. The guidance provided may be for content available only through a television, for content available only through one or more of other types of user equipment devices, or for content available both through a television and one or more of the other types of user equipment devices. The media guidance applications may be provided as on-line applications (i.e., provided on a website), or as stand-alone applications or clients on user equipment devices. Various devices and platforms that may implement media guidance applications are described in more detail below.

One of the functions of the media guidance application is to provide media guidance data to users. As referred to herein, the phrase, “media guidance data” or “guidance data” should be understood to mean any data related to content, such as media listings, media-related information (e.g., broadcast times, broadcast channels, titles, descriptions, ratings information (e.g., parental control ratings, critic's ratings, etc.), genre or category information, actor information, logo data for broadcasters' or providers' logos, etc.), media format (e.g., standard definition, high definition, 3D, etc.), advertisement information (e.g., text, images, media clips, etc.), on-demand information, blogs, websites, and any other type of guidance data that is helpful for a user to navigate among and locate desired content selections.

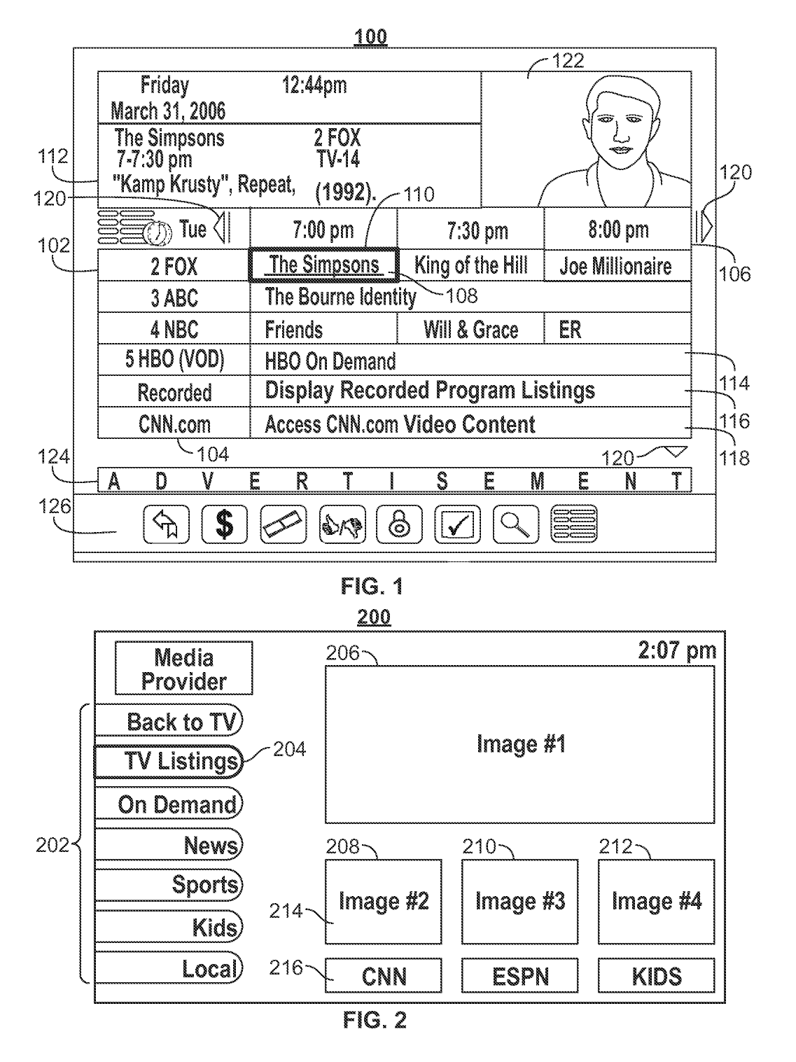

FIGS. 1-2 show illustrative display screens that may be used to provide media guidance data. The display screens shown in FIGS. 1-2 and 6-8 may be implemented on any suitable user equipment device or platform. While the displays of FIGS. 1-2 and 6-8 are illustrated as full screen displays, they may also be fully or partially overlaid over content being displayed. A user may indicate a desire to access content information by selecting a selectable option provided in a display screen (e.g., a menu option, a listings option, an icon, a hyperlink, etc.) or pressing a dedicated button (e.g., a GUIDE button) on a remote control or other user input interface or device. In response to the user's indication, the media guidance application may provide a display screen with media guidance data organized in one of several ways, such as by time and channel in a grid, by time, by channel, by source, by content type, by category (e.g., movies, sports, news, children, or other categories of programming), or other predefined, user-defined, or other organization criteria. The organization of the media guidance data is determined by guidance application data. As referred to herein, the phrase, “guidance application data” should be understood to mean data used in operating the guidance application, such as program information, guidance application settings, user preferences, or user profile information.

FIG. 1 shows illustrative grid program listings display 100 arranged by time and channel that also enables access to different types of content in a single display. Display 100 may include grid 102 with: (1) a column of channel/content type identifiers 104, where each channel/content type identifier (which is a cell in the column) identifies a different channel or content type available; and (2) a row of time identifiers 106, where each time identifier (which is a cell in the row) identifies a time block of programming. Grid 102 also includes cells of program listings, such as program listing 108, where each listing provides the title of the program provided on the listing's associated channel and time. With a user input device, a user can select program listings by moving highlight region 110. Information relating to the program listing selected by highlight region 110 may be provided in program information region 112. Region 112 may include, for example, the program title, the program description, the time the program is provided (if applicable), the channel the program is on (if applicable), the program's rating, and other desired information.

In addition to providing access to linear programming (e.g., content that is scheduled to be transmitted to a plurality of user equipment devices at a predetermined time and is provided according to a schedule), the media guidance application also provides access to non-linear programming (e.g., content accessible to a user equipment device at any time and is not provided according to a schedule). Non-linear programming may include content from different content sources including on-demand content (e.g., VOD), Internet content (e.g., streaming media, downloadable media, etc.), locally stored content (e.g., content stored on any user equipment device described above or other storage device), or other time-independent content. On-demand content may include movies or any other content provided by a particular content provider (e.g., HBO On Demand providing “The Sopranos” and “Curb Your Enthusiasm”). HBO ON DEMAND is a service mark owned by Time Warner Company L.P. et al. and THE SOPRANOS and CURB YOUR ENTHUSIASM are trademarks owned by the Home Box Office, Inc. Internet content may include web events, such as a chat session or Webcast, or content available on-demand as streaming content or downloadable content through an Internet website or other Internet access (e.g. FTP).

Grid 102 may provide media guidance data for non-linear programming including on-demand listing 114, recorded content listing 116, and Internet content listing 118. A display combining media guidance data for content from different types of content sources is sometimes referred to as a “mixed-media” display. Various permutations of the types of media guidance data that may be displayed that are different than display 100 may be based on user selection or guidance application definition (e.g., a display of only recorded and broadcast listings, only on-demand and broadcast listings, etc.). As illustrated, listings 114, 116, and 118 are shown as spanning the entire time block displayed in grid 102 to indicate that selection of these listings may provide access to a display dedicated to on-demand listings, recorded listings, or Internet listings, respectively. In some embodiments, listings for these content types may be included directly in grid 102. Additional media guidance data may be displayed in response to the user selecting one of the navigational icons 120. (Pressing an arrow key on a user input device may affect the display in a similar manner as selecting navigational icons 120.)

Display 100 may also include video region 122, advertisement 124, and options region 126. Video region 122 may allow the user to view and/or preview programs that are currently available, will be available, or were available to the user. The content of video region 122 may correspond to, or be independent from, one of the listings displayed in grid 102. Grid displays including a video region are sometimes referred to as picture-in-guide (PIG) displays. PIG displays and their functionalities are described in greater detail in Satterfield et al. U.S. Pat. No. 6,564,378, issued May 13, 2003 and Yuen et al. U.S. Pat. No. 6,239,794, issued May 29, 2001, which are hereby incorporated by reference herein in their entireties. PIG displays may be included in other media guidance application display screens of the embodiments described herein.

Advertisement 124 may provide an advertisement for content that, depending on a viewer's access rights (e.g., for subscription programming), is currently available for viewing, will be available for viewing in the future, or may never become available for viewing, and may correspond to or be unrelated to one or more of the content listings in grid 102. Advertisement 124 may also be for products or services related or unrelated to the content displayed in grid 102. Advertisement 124 may be selectable and provide further information about content, provide information about a product or a service, enable purchasing of content, a product, or a service, provide content relating to the advertisement, etc. Advertisement 124 may be targeted based on a user's profile/preferences, monitored user activity, the type of display provided, or on other suitable targeted advertisement bases.

While advertisement 124 is shown as rectangular or banner shaped, advertisements may be provided in any suitable size, shape, and location in a guidance application display. For example, advertisement 124 may be provided as a rectangular shape that is horizontally adjacent to grid 102. This is sometimes referred to as a panel advertisement. In addition, advertisements may be overlaid over content or a guidance application display or embedded within a display. Advertisements may also include text, images, rotating images, video clips, or other types of content described above. Advertisements may be stored in a user equipment device having a guidance application, in a database connected to the user equipment, in a remote location (including streaming media servers), or on other storage means, or a combination of these locations. Providing advertisements in a media guidance application is discussed in greater detail in, for example, Knudson et al., U.S. Patent Application Publication No. 2003/0110499, filed Jan. 17, 2003; Ward, III et al. U.S. Pat. No. 6,756,997, issued Jun. 29, 2004; and Schein et al. U.S. Pat. No. 6,388,714, issued May 14, 2002, which are hereby incorporated by reference herein in their entireties. It will be appreciated that advertisements may be included in other media guidance application display screens of the embodiments described herein.

Options region 126 may allow the user to access different types of content, media guidance application displays, and/or media guidance application features. Options region 126 may be part of display 100 (and other display screens described herein), or may be invoked by a user by selecting an on-screen option or pressing a dedicated or assignable button on a user input device. The selectable options within options region 126 may concern features related to program listings in grid 102 or may include options available from a main menu display. Features related to program listings may include searching for other air times or ways of receiving a program, recording a program, enabling series recording of a program, setting program and/or channel as a favorite, purchasing a program, or other features. Options available from a main menu display may include search options, VOD options, parental control options, Internet options, cloud-based options, device synchronization options, second screen device options, options to access various types of media guidance data displays, options to subscribe to a premium service, options to edit a user's profile, options to access a browse overlay, or other options.

The media guidance application may be personalized based on a user's preferences. A personalized media guidance application allows a user to customize displays and features to create a personalized “experience” with the media guidance application. This personalized experience may be created by allowing a user to input these customizations and/or by the media guidance application monitoring user activity to determine various user preferences. Users may access their personalized guidance application by logging in or otherwise identifying themselves to the guidance application. Customization of the media guidance application may be made in accordance with a user profile. The customizations may include varying presentation schemes (e.g., color scheme of displays, font size of text, etc.), aspects of content listings displayed (e.g., only HDTV or only 3D programming, user-specified broadcast channels based on favorite channel selections, re-ordering the display of channels, recommended content, etc.), desired recording features (e.g., recording or series recordings for particular users, recording quality, etc.), parental control settings, customized presentation of Internet content (e.g., presentation of social media content, e-mail, electronically delivered articles, etc.) and other desired customizations.

Each user profile may contain parental control restrictions. A user profile may be configured with access to specific types of content. Access to specific types of content may be configured by establishing access rules such as allowing a user with a specific user profile access to media content associated with certain parental control ratings. A user profile may also contain more specialized parental control settings such as blocking access to media content associated with certain genres, subjects, and actors. Parental control settings may also prevent the user of a specific user profile from accessing certain content sources or prevent the user from accessing specific content sources at certain times of the day.

Once a user profile is set up with these access rules, the media guidance application may check the access rules once a media asset is requested to determine whether the user associated with a specific user profile is allowed to access the requested media content. Alternatively, the media guidance application may search all media content listings available in a media guidance database to determine which media assets the user profile is allowed to access.

The media guidance application may allow a user to provide user profile information or may automatically compile user profile information. The media guidance application may, for example, monitor the content the user accesses and/or other interactions the user may have with the guidance application. Additionally, the media guidance application may obtain all or part of other user profiles that are related to a particular user (e.g., from other websites on the Internet the user accesses, such as www.allrovi.com, from other media guidance applications the user accesses, from other interactive applications the user accesses, from another user equipment device of the user, etc.), and/or obtain information about the user from other sources that the media guidance application may access. As a result, a user can be provided with a unified guidance application experience across the user's different user equipment devices. This type of user experience is described in greater detail below in connection with FIG. 4. Additional personalized media guidance application features are described in greater detail in Ellis et al., U.S. Patent Application Publication No. 2005/0251827, filed Jul. 11, 2005, Boyer et al., U.S. Pat. No. 7,165,098, issued Jan. 16, 2007, and Ellis et al., U.S. Patent Application Publication No. 2002/0174430, filed Feb. 21, 2002, which are hereby incorporated by reference herein in their entireties.

Another display arrangement for providing media guidance is shown in FIG. 2. Video mosaic display 200 includes selectable options 202 for content information organized based on content type, genre, and/or other organization criteria. In display 200, television listings option 204 is selected, thus providing listings 206, 208, 210, and 212 as broadcast program listings. In display 200 the listings may provide graphical images including cover art, still images from the content, video clip previews, live video from the content, or other types of content that indicate to a user the content being described by the media guidance data in the listing. Each of the graphical listings may also be accompanied by text to provide further information about the content associated with the listing. For example, listing 208 may include more than one portion, including media portion 214 and text portion 216. Media portion 214 and/or text portion 216 may be selectable to view content in full-screen or to view information related to the content displayed in media portion 214 (e.g., to view listings for the channel that the video is displayed on).

The listings in display 200 are of different sizes (i.e., listing 206 is larger than listings 208, 210, and 212), but if desired, all the listings may be the same size. Listings may be of different sizes or graphically accentuated to indicate degrees of interest to the user or to emphasize certain content, as desired by the content provider or based on user preferences. Various systems and methods for graphically accentuating content listings are discussed in, for example, Yates, U.S. Patent Application Publication No. 2010/0153885, filed Dec. 29, 2005, which is hereby incorporated by reference herein in its entirety.

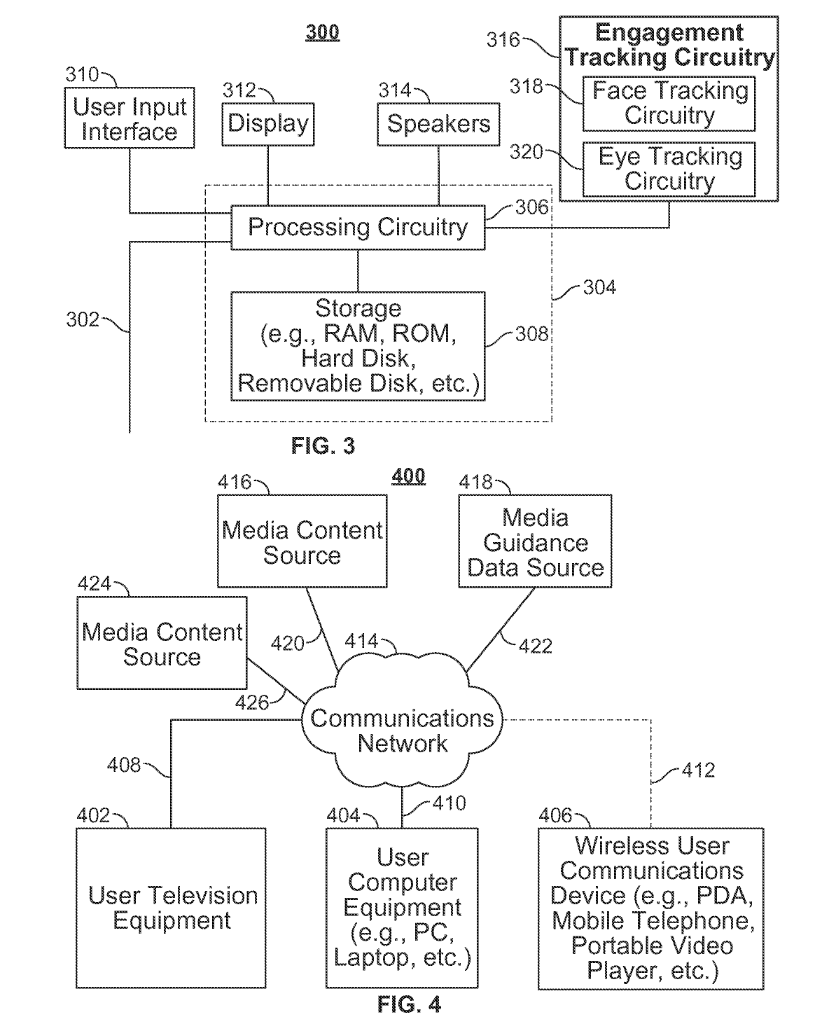

Users may access content and the media guidance application (and its display screens described above and below) from one or more of their user equipment devices. FIG. 3 shows a generalized embodiment of illustrative user equipment device 300. More specific implementations of user equipment devices are discussed below in connection with FIG. 4. User equipment device 300 may receive content and data via input/output (hereinafter “I/O”) path 302. I/O path 302 may provide content (e.g., broadcast programming, on-demand programming, Internet content, content available over a local area network (LAN) or wide area network (WAN), and/or other content) and data to control circuitry 304, which includes processing circuitry 306 and storage 308. Control circuitry 304 may be used to send and receive commands, requests, and other suitable data using I/O path 302. I/O path 302 may connect control circuitry 304 (and specifically processing circuitry 306) to one or more communications paths (described below). I/O functions may be provided by one or more of these communications paths, but are shown as a single path in FIG. 3 to avoid overcomplicating the drawing.

Control circuitry 304 may be based on any suitable processing circuitry such as processing circuitry 306. As referred to herein, processing circuitry should be understood to mean circuitry based on one or more microprocessors, microcontrollers, digital signal processors, programmable logic devices, field-programmable gate arrays (FPGAs), application-specific integrated circuits (ASICs), etc., and may include a multi-core processor (e.g., dual-core, quad-core, hexa-core, or any suitable number of cores) or supercomputer. In some embodiments, processing circuitry may be distributed across multiple separate processors or processing units, for example, multiple of the same type of processing units (e.g., two Intel Core i7 processors) or multiple different processors (e.g., an Intel Core i5 processor and an Intel Core i7 processor). In some embodiments, control circuitry 304 executes instructions for a media guidance application stored in memory (i.e., storage 308). Specifically, control circuitry 304 may be instructed by the media guidance application to perform the functions discussed above and below. For example, the media guidance application may provide instructions to control circuitry 304 to generate the media guidance displays. In some implementations, any action performed by control circuitry 304 may be based on instructions received from the media guidance application.

In client-server based embodiments, control circuitry 304 may include communications circuitry suitable for communicating with a guidance application server or other networks or servers. The instructions for carrying out the above mentioned functionality may be stored on the guidance application server. Communications circuitry may include a cable modem, an integrated services digital network (ISDN) modem, a digital subscriber line (DSL) modem, a telephone modem, Ethernet card, or a wireless modem for communications with other equipment, or any other suitable communications circuitry. Such communications may involve the Internet or any other suitable communications networks or paths (which is described in more detail in connection with FIG. 4). In addition, communications circuitry may include circuitry that enables peer-to-peer communication of user equipment devices, or communication of user equipment devices in locations remote from each other (described in more detail below).

Memory may be an electronic storage device provided as storage 308 that is part of control circuitry 304. As referred to herein, the phrase “electronic storage device” or “storage device” should be understood to mean any device for storing electronic data, computer software, or firmware, such as random-access memory, read-only memory, hard drives, optical drives, digital video disc (DVD) recorders, compact disc (CD) recorders, BLU-RAY disc (BD) recorders, BLU-RAY 3D disc recorders, digital video recorders (DVR, sometimes called a personal video recorder, or PVR), solid state devices, quantum storage devices, gaming consoles, gaming media, or any other suitable fixed or removable storage devices, and/or any combination of the same. Storage 308 may be used to store various types of content described herein as well as media guidance information, described above, and guidance application data, described above. Nonvolatile memory may also be used (e.g., to launch a boot-up routine and other instructions). Cloud-based storage, described in relation to FIG. 4, may be used to supplement storage 308 or instead of storage 308.

Control circuitry 304 may include video generating circuitry and tuning circuitry, such as one or more analog tuners, one or more MPEG-2 decoders or other digital decoding circuitry, high-definition tuners, or any other suitable tuning or video circuits or combinations of such circuits. Encoding circuitry (e.g., for converting over-the-air, analog, or digital signals to MPEG signals for storage) may also be provided. Control circuitry 304 may also include scaler circuitry for upconverting and downconverting content into the preferred output format of the user equipment 300. Circuitry 304 may also include digital-to-analog converter circuitry and analog-to-digital converter circuitry for converting between digital and analog signals. The tuning and encoding circuitry may be used by the user equipment device to receive and to display, to play, or to record content. The tuning and encoding circuitry may also be used to receive guidance data. The circuitry described herein, including for example, the tuning, video generating, encoding, decoding, encrypting, decrypting, scaler, and analog/digital circuitry, may be implemented using software running on one or more general purpose or specialized processors. Multiple tuners may be provided to handle simultaneous tuning functions (e.g., watch and record functions, picture-in-picture (PIP) functions, multiple-tuner recording, etc.). If storage 308 is provided as a separate device from user equipment 300, the tuning and encoding circuitry (including multiple tuners) may be associated with storage 308.

A user may send instructions to control circuitry 304 using user input interface 310. User input interface 310 may be any suitable user interface, such as a remote control, mouse, trackball, keypad, keyboard, touch screen, touchpad, stylus input, joystick, voice recognition interface, or other user input interfaces. Display 312 may be provided as a stand-alone device or integrated with other elements of user equipment device 300. Display 312 may be one or more of a monitor, a television, a liquid crystal display (LCD) for a mobile device, or any other suitable equipment for displaying visual images. In some embodiments, display 312 may be HDTV-capable. In some embodiments, display 312 may be a 3D display, and the interactive media guidance application and any suitable content may be displayed in 3D. A video card or graphics card may generate the output to the display 312. The video card may offer various functions such as accelerated rendering of 3D scenes and 2D graphics, MPEG-2/MPEG-4 decoding, TV output, or the ability to connect multiple monitors. The video card may be any processing circuitry described above in relation to control circuitry 304. The video card may be integrated with the control circuitry 304. Speakers 314 may be provided as integrated with other elements of user equipment device 300 or may be stand-alone units. The audio component of videos and other content displayed on display 312 may be played through speakers 314. In some embodiments, the audio may be distributed to a receiver (not shown), which processes and outputs the audio via speakers 314.

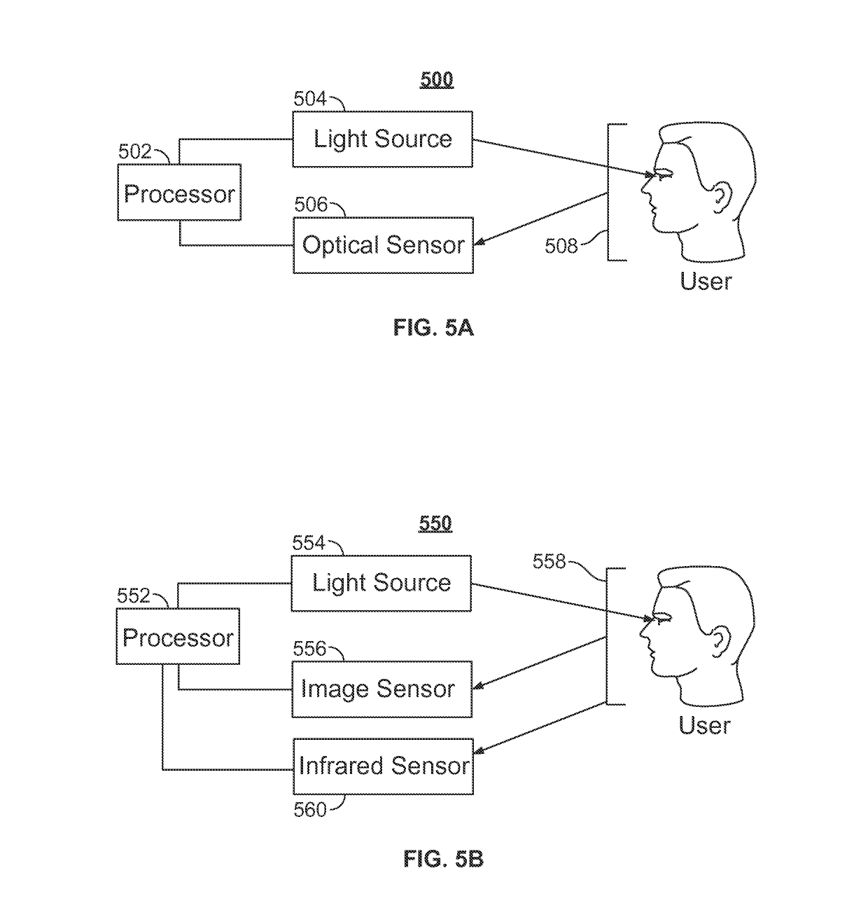

User equipment device 300 may determine whether a user is watching display 312 using engagement tracking circuitry 316. In several embodiments, engagement tracking circuitry 316 may include an eye tracker 320. Eye tracker 320 may receive a location upon which one or both of a user's eyes are focused. The location upon which a user's eyes are focused is referred to herein as the user's “gaze point.” In some embodiments, eye tracker 320 may monitor one of both eyes of a user of user equipment 300 to identify a gaze point on display 312 for the user. Eye tracker 320 may additionally or alternatively determine whether one or both eyes of the user are focused on display 312 or focused on a location that is not on display 312. In some embodiments, eye tracker 320 includes one or more sensors that transmit data to processing circuitry 306, which determines a user's gaze point. Eye tracker 320 may be integrated with other elements of user equipment device 300, or eye tracker 320 may be a separate device or system in communication with user equipment device 300. Eye tracker 320 is described in further detail in relation to FIG. 5.

In some embodiments, control circuitry 304 may be configured to assign an engagement level value based on the monitored eye tracking data. For example, control circuitry 304 may receive the gaze tracking data collected by eye tracker 320 and store that data in a memory unit such as storage 308. Control circuitry 304 may analyze the location of the gaze point with respect to display 312 to determine the engagement level of the user with respect to display 312. Control circuitry 304 may calculate an eye tracking score on the location of the user's gaze point at a given time with respect to display 312. Control circuitry 304 may store the calculated eye tracking score in a database in storage 308. Control circuitry 304 may factor in the eye tracking score along with several other parameters used to measure a user's engagement level to calculate a user engagement level value with user equipment device 300.

In several other embodiments, engagement tracking circuitry 316 may include face tracker 318. Face tracker 318 may determine the position and orientation of the user's face with respect to display 312 in order to measure the level of user engagement with the displayed media asset. Face tracker 318 may use an optical device and facial recognition software in order to detect a user's face. Once a user's face has been detected, face tracker 318 may compare the detected face against a database of known user faces stored in a database in storage 308 using facial recognition software. For example, face tracker 318 may use an optical device to capture an image of a detected face within proximity of user equipment device 300. Face tracker 318 may then use facial recognition software to process the captured image and compare the processed image against a database of registered users' faces stored in a database on storage 308. Once a matching face in the database of users' faces is found, processing circuitry 306 may identify the user profile associated with the detected face.

Face tracker 318 may monitor the position and orientation of the detected user's face once a matching user profile has been identified with the detected user's face. In particular, face tracker 318 may monitor the tilt of the face with relation to display 312. For instance, face tracker 318 may monitor whether the user is facing display 312 or whether the user's face is oriented sideways with respect to display 312 and is not looking directly at display 312. The degree of the tilt between the user's face and display 312 is used to measure the engagement level of the user. Face tracker 318 may also monitor the position of the user's face with relation to display 312 to determine the distance between the user's face and display 312 and to determine the angle of the user's face from the center of display 312. Such data collected by face tracker 318 determines how likely the user is to be engaged with display 312.

In some embodiments, control circuitry 304 may be configured to assign an engagement level value based on the monitored face tracking data. For example, control circuitry 304 may receive the face tracking data collected by face tracker 318 and store that data in a memory unit such as storage 308. Control circuitry 304 may analyze data describing the user's facial orientation with respect to display 312 to determine the level of engagement of the user with the user equipment device 300. For instance, control circuitry 304 may calculate a face tracking score based on the angle of the user's face with respect to display 312 measured by face tracker 318. Control circuitry 304 may additionally factor in the user's facial position with respect to display 312 to calculate the face tracking score. Once control circuitry 304 calculates such a face tracking score, control circuitry 304 may calculate an engagement level value using the face tracking score. For instance, control circuitry 304 may perform a weighted average of the face tracking score and the eye tracking score to calculate a total user engagement level value with user equipment 300.

Control circuitry 304 may store the calculated engagement level value in a database in storage 308. Control circuitry 304 may assign such an engagement level at periodic time intervals or continuously update a database of user engagement level with values of user engagement values based on the monitored eye tracking data received from eye tracker 320. In some embodiments, control circuitry 304 may also transmit the user's calculated engagement level value to other user equipment devices over a wireless network.

In some embodiments, face tracker 318 may capture a video of the user's face to measure the engagement level of the user. Alternatively, face tracker 318 may capture a set of image frames of a user's face. Control circuitry 304 may check for differences in facial features between different video frames or captured images. Control circuitry 304 may compare the differences in facial features, position, and orientation with respect to display 312 to update the user engagement level. For instance, control circuitry 304 may measure the change in facial features, position, and orientation with respect to display 312 for an image frame with respect to such data from an initial image frame. Control circuitry 304 may then accordingly adjust the face tracking score proportionately with respect to the offsets in these measured facial values for an image captured after an initially captured image of the user's face.

Face tracker 318 and eye tracker 320 may be used in combination to determine the engagement level of a user associated with a user profile with display 312. Processing circuitry 306 may use gaze tracking data and facial position and orientation data in combination to determine a composite score of the user's level of engagement with display 312. For example, processing circuitry 306 analyzes the face tracking and eye tracking data for each user and calculates a composite user engagement level score based on the analyzed data.

Storage 308 may include a stored database of user profiles associated with user equipment device 300. Each user profile may include at least one or more images of a user's face, parental control settings associated with the user, and media viewing preferences of the user. A user profile may also include a default user engagement level threshold. An engagement level threshold is a numerical measure of a user's level of activity with user equipment device 300. Such a value may be calibrated in accordance with the techniques in which control circuitry 304 calculates a user engagement level using data from eye tracker 320, face tracker 318, and any other components of engagement tracking circuitry 316.

The user profile may also include a list of media assets that the user currently owns or has access to. For instance, the user profile may include a list of media assets that the user has purchased from an online store, a list of media assets that the user has rented, and a list of media assets that are stored in networked storage devices. Alternatively, the user profile may be stored at a remote media guidance server that user equipment 300 can access.

In some embodiments, control circuitry 304 may detect that a user is within proximity of display 312. Control circuitry 304 may receive engagement level information from engagement tracking circuitry 316. Such engagement level information includes facial recognition information from face tracker 318. Once such facial recognition information is received, control circuitry 304 identifies the user profile associated with the detected user. For example, control circuitry 304 matches the facial recognition information received from face tracker 318 against the database of user profiles in storage 308 to identify the detected user.

In some embodiments, once a user is identified, control circuitry 304 populates the media guidance application with media listings for on-demand media assets accessible to the user. Control circuitry 304 accesses the identified user's profile and identifies the on-demand media assets that the user has access to. Once control circuitry 304 identifies the on-demand media assets, control circuitry 304 may generate the media listings for these assets.

In some embodiments, control circuitry 304 searches multiple media sources for on-demand media assets that are accessible to the user. Control circuitry 304 may search multiple Internet databases of different content distribution networks for on-demand media assets that the user has access to. For example, control circuitry 304 may search Amazon's Online Instant Video service or Netflix's Online Video service for on-demand media assets that the user has access to. Control circuitry 304 may be able to search the online databases for these content distribution networks using user login information for these online content distribution networks found in the user's profile. In addition, control circuitry 304 may search storage 308 of user equipment 300 for locally stored on-demand media assets that the user may have purchased. In addition, control circuitry 304 may search storage devices such as external hard drives, computers, portable DVD and Blu-Ray players, smartphones, tablets, and videogame consoles that belong to the same network as user equipment 300 for on-demand media assets that the user has access to.

In some embodiments, control circuitry 304 may further refine searching these media sources based on any user preferences for the type of on-demand content stored in the user's profile. For instance, the user profile may specify that the user prefers media content from a specific genre i.e., action and adventure. In this case, control circuitry 304 would search the media sources for on-demand media assets that fall within the action and adventure genre that the user has access to. Control circuitry 304 may search for on-demand media assets that fit the user preferences by searching the metadata and tags for on-demand media assets stored in these various media sources. In other embodiments, control circuitry 304 may refine searching the various media sources based on a plurality of user preference criteria found in the user profile. For example the user may have expressed an interest for action and adventure programs with a specific actor i.e., Robert Downey, Jr. In this case, control circuitry 304 may search the various media sources for action and adventure programs starring Robert Downey, Jr. that the user has access to. Control circuitry 304 may retrieve content that matches one or more of the user preferences stored in the user profile from these various media sources.

Once control circuitry 304 identifies the on-demand media assets from the various media sources that match the user profile and that the user has access to, control circuitry 304 may generate a media asset listing for each of the identified on-demand media assets.

In some embodiments, control circuitry 304 may allocate the media asset listings for the identified on-demand media assets to one on-demand channel in the media guidance application. Each of the identified on-demand media assets may be scheduled to be displayed one after the other on the on-demand channel. In another embodiment, control circuitry 304 may allocate the media asset listings for the identified on-demand media assets to several on-demand channels in the media guidance application.

In some embodiments, an order is determined in which the identified on-demand media assets are placed in the on-demand media asset channel or channels. The purpose of such an ordering is to ensure that the user watches content that he has not watched in a given period of time. Control circuitry 304 may generate a list of identified on-demand media assets that are available to the user and match the preferences specified in the user's profile. Control circuitry 304 may examine the metadata associated with each of the on-demand media assets in the generated list of identified media assets to identify the date on which that on-demand media asset was last accessed by the user or at user equipment 300. Control circuitry 304 may store these last accessed dates in storage 308. Control circuitry 304 may further determine whether any of the on-demand media assets on the list of identified media assets have never been accessed by the user at user equipment 300. If control circuitry 304 determines that there are any on-demand media assets that have not been accessed at user equipment 300, control circuitry 304 will prioritize these on-demand media assets in the placement order of media assets in the on-demand channel or on-demand channels. Control circuitry 304 may also order the placement of the assets that have been accessed at least once at user equipment 300 based on the date each asset was last accessed at user equipment 300. In another implementation, control circuitry 300 may retrieve a user specified value in a user profile that sets the user preference for watching programs that he has not watched for at least a specific amount of time (i.e., one month, one year, etc.). Control circuitry 304 may retrieve this user specified value from the user profile and may only place on-demand media assets from the list of identified media assets that the user has not watched for at least the user specified amount of time.

In some embodiments, control circuitry 304 calculates the amount of time it would take to buffer the on-demand media assets in those on-demand channels. For example, control circuitry 304 identifies the bit rate of the connection between user equipment 300 and the media source from which the identified media asset is to be received. Based on this identified bit rate, control circuitry 304 calculates the amount of buffering time required before media assets from a given media source can be played back at user equipment.

In some embodiments, control circuitry 304 automatically determines the placement location of the on-demand channels in a media guidance application grid based on the amount of time it would take to buffer the on-demand media assets in those on-demand channels. Control circuitry 304 may place the on-demand channels at media guidance grid locations that would take the user a period of time longer than the buffering time required to receive the on-demand media asset at user equipment 300. For example, control circuitry 304 may determine the currently selected media asset listing's location in the media guidance grid location or may determine the default media guidance grid location every time the user chooses to access the media guidance application. Once control circuitry 304 determines this initial location, control circuitry 304 calculates the minimum number of channels to place between the initial location and the on-demand channel location based on the buffering time, hereinafter referred to as the predetermined buffering channel pad. For example, control circuitry 304 calculates the fastest user browsing speed in terms of the amount of time it takes a user to scroll through the media guidance grid. Control circuitry 304 subsequently places the on-demand channel or channels at a grid location that is located at least the calculated number of channels away from the initial channel location.

In another embodiment, control circuitry 304 may insert the on-demand channel in between preexisting channels based on the channel that the user is viewing. For example, control circuitry 304 may determine that the channel number of the channel that the user is currently viewing. Control circuitry 304 may further determine that the user is channel surfing by determining that the user is changing channels in a sequential manner (i.e., pressing the channel up or channel down key on the remote control). Based on such a determination, control circuitry 304 may insert an on-demand channel with a calculated distance from channel that the user is currently viewing. Control circuitry 304 may calculate this channel distance based on the amount of buffer time required to receive the on-demand asset in the inserted on-demand channel at user equipment 300 from the on-demand media asset's media source. In this embodiment, control circuitry 304 may calculate the predetermined buffering channel pad by monitoring the rate at which the user is changing channels. For instance, control circuitry 304 determines the direction and the average rate at which the user is changing channels. For example, control circuitry 304 may determine that the user is pressing channel up on his remote control and spending an average time of 5 seconds per channel. Based on such information, control circuitry 304 may calculate the time required to buffer the on-demand media asset to be shown on the on-demand channel to be inserted. Control circuitry 304 may determine that if the on-demand media asset requires 50 seconds to buffer, then the predetermined buffering channel pad is 10 channels based on the current user channel browsing rate of 5 seconds per channel. Accordingly, control circuitry 304 may place the on-demand channel at least 10 channels after the currently viewed channel if the user is pressing channel up consistently.

In other embodiments, control circuitry 304 automatically determines the placement location of the on-demand channels based on factors unrelated to buffering time. For instance, control circuitry 304 may place the on-demand channels after the conventional broadcast channels. In another implementation, control circuitry 304 may place the on-demand channels in random locations throughout the media guidance grid. In another implementation, control circuitry 304 may place the on-demand channels as the first channel listings in the media guidance grid.

In another embodiment, control circuitry 304 provides the user with the option to select the placement location of one or more on-demand channels in the media guidance grid. Control circuitry 304 may display a prompt on display 312 that provides the user with an option to enter one or more channel numbers in which on-demand media assets will be placed. Control circuitry 304 may receive the channel number input from user input interface 310 and accordingly create the one or more on-demand channels at the user-specified channel locations.

In some embodiments, control circuitry 304 begins buffering the on-demand media asset when the user is browsing the media guidance grid at a grid location that is a predetermined amount of channels away from the on-demand channel in which the on-demand media asset is placed. For example, control circuitry 304 monitors the currently selected media asset listing as the user is browsing media listings in the media guidance grid. Once control circuitry 304 determines that the user is within the predetermined buffering channel pad, control circuitry 304 determines whether the user is scrolling towards the on-demand media channel. Control circuitry 304 checks to see whether it has received an input from user input interface 310 to select a different media asset listing closer to the on-demand media asset channel. If control circuitry 304 determines that it has received such an input, control circuitry 304 begins buffering the on-demand media asset scheduled for current display on the on-demand media channel.

In some embodiments, control circuitry 304 may retrieve content from the media source after a certain reference event occurs. Control circuitry 304 may download the identified on-demand media assets from the media source or may stream the on-demand media assets from the media source to storage 308. A reference event may be the powering on of display 312 or user equipment 300. Another reference event may be the creation of a media asset listing corresponding to the on-demand media asset. Another reference event may occur when control circuitry 304 detects the user within proximity of user equipment 300. Another reference event may occur when control circuitry 304 determines that the user is viewing the user equipment 300, including display 312. Another reference event may occur when control circuitry 304 determines that the user is engaged with display 312. Another reference event may occur when the user begins browsing the interactive media guidance application.

In some embodiments, once a determination has been made by control circuitry 304 that a reference event has occurred, control circuitry 304 searches through one or more storage devices that are part of the same wireless or local area network as user equipment 300 for a suitable media asset. For instance, control circuitry 304 searches the storage devices for at least one media asset that matches the user's profile. Once control circuitry 304 detects that a reference event has occurred, control circuitry 304 may detect all of the storage devices that are located on the same wireless network as user equipment 300. Upon detecting all the networked storage devices, control circuitry 304 may further determine to see whether the user has access to content stored in these networked storage devices. For example, control circuitry 304 may check the storage devices to see whether they require authorization information. If such access authorization is required control circuitry 304 may prompt the user to enter such login information. Alternatively, control circuitry 304 may retrieve previously stored authorization information for such networked storage devices from storage 308.

Once the user is authenticated and able to access the networked storage device, control circuitry 304 searches the media assets stored on that device for at least one media asset that matches the user's profile. For instance, the user may have specified that he is interested in watching from a specific genre (i.e., romantic comedy) or programs with a specific actor (i.e., Tom Hanks). These preferences are stored in user profile which may be stored in storage 308. Control circuitry 304 queries the user profile in searching the networked storage devices for an asset that the user would prefer to receive. Control circuitry 304 may search the metadata associated with the stored media assets on the networked storage devices to determine whether they match the user preferences specified in the user's profile.

Once control circuitry 304 identifies at least one media asset from the networked devices, control circuitry 304 may generate a media asset channel on which the identified media asset is presented. Control circuitry 304 may also generate a media asset listing for the identified program from the storage devices in order to place the media listing for the identified media asset in a media listing grid.

In some embodiments, control circuitry 304 may receive a user input requesting display of the media asset at user equipment 300. For example, while browsing media grid 100, the user may select a media asset listing for the identified media asset from a networked storage device. Upon receiving such a request to display the identified media asset, control circuitry 304 may retrieve the stored media asset from the networked media device. Control circuitry 304 may also measure the amount of time that has elapsed from when control circuitry 304 determined that a reference event had occurred until the input to display the identified media asset is received at user equipment 300. [0086] Upon receiving the input to display the identified media asset at display 312, control circuitry 304 may retrieve the media asset from the networked storage device. For instance, control circuitry 304 may instruct the networked storage device that contains the stored media asset to transmit the identified media asset to user equipment 300 over the wireless network. Upon receiving the media asset at user equipment 300, control circuitry 304 may cause the identified media asset to be presented on display 312 from a play position offset from the beginning of the media asset by the measured amount of elapsed time between the reference event and the user request to display the media asset that control circuitry 304 had previously calculated. Beginning playback from such a position allows for a more seamless viewing experience where the user views the selected media asset from a playback position after the beginning. This allows the media asset retrieved from a networked storage device to be played back in the same manner as a conventional broadcast media asset, which lessens the distinction between such stored media assets and broadcast media assets to create a more seamless viewing experience. In another embodiment, control circuitry 304 may receive a user input to restart playback of the media asset from the beginning of the media asset. In response to receiving such an input, control circuitry 304 starts playback of the retrieved media asset from the networked storage device from the beginning of the media asset.

In some embodiments, control circuitry 304 may identify multiple media assets that match the user preferences stored in the user profile upon searching the networked storage devices. Control circuitry 304 may generate additional media asset listings for each of the media asset listings upon identifying these additional media asset listings based on searching the networked storage devices.

In some embodiments, control circuitry 304 calculates the amount of time it would take to buffer the identified media assets from the networked storage devices. For example, control circuitry 304 identifies the bit rate of the wireless connection between user equipment 300 and the networked storage device from which the identified media asset is to be received. Based on this identified bit rate, control circuitry 304 calculates the amount of buffering time required before media assets from a given networked storage device can be played back at user equipment 300.

In some embodiments, control circuitry 304 automatically determines the placement location of the generated channels in a media guidance application grid based on the amount of time it would take to buffer the stored media assets in those channels. Control circuitry 304 may place the generated channels at media guidance grid locations that would take the user a period of time longer than the buffering time required to receive the identified media asset at user equipment 300. For example, control circuitry 304 may determine the currently selected media asset listing's location in the media guidance grid location or may determine the default media guidance grid location every time the user chooses to access the media guidance application. Once control circuitry 304 determines this initial location, control circuitry 304 calculates the predetermined buffering channel pad. For example, control circuitry 304 calculates the fastest user browsing speed in terms of the amount of time it takes a user to scroll through the media guidance grid. Control circuitry 304 subsequently places the generated channel or channels at a grid location that is located at least the calculated number of channels away from the initial channel location.

In another embodiment, control circuitry 304 may insert the generated channel in between preexisting channels based on the channel that the user is viewing. For example, control circuitry 304 may determine that the channel number of the channel that the user is currently viewing. Control circuitry 304 may further determine that the user is channel surfing by determining that the user is changing channels in a sequential manner (i.e., pressing the channel up or channel down key on the remote control). Based on such a determination, control circuitry 304 may insert a generated channel with a calculated distance from channel that the user is currently viewing. Control circuitry 304 may calculate this channel distance based on the amount of buffer time required to receive the identified media asset in the inserted channel at user equipment 300 from the identified media asset's networked storage device. In this embodiment, control circuitry 304 may calculate the predetermined buffering channel pad by monitoring the rate at which the user is changing channels. For instance, control circuitry 304 determines the direction and the average rate at which the user is changing channels. For example, control circuitry 304 may determine that the user is pressing channel up on his remote control and spending an average time of 5 seconds per channel. Based on such information, control circuitry 304 may calculate the time required to buffer the stored media asset to be shown on the channel to be inserted. Control circuitry 304 may determine that if the stored media asset requires 50 seconds to buffer, then the predetermined buffering channel pad is 10 channels based on the current user channel browsing rate of 5 seconds per channel. Accordingly, control circuitry 304 may place the generated channel at least 10 channels after the currently viewed channel if the user is pressing channel up consistently.

In other embodiments, control circuitry 304 automatically determines the placement location of the on-demand channels based on factors unrelated to buffering time. For instance, control circuitry 304 may place the generated channels after the conventional broadcast channels. In another implementation, control circuitry 304 may place the on-demand channels in random locations throughout the media guidance grid. In another implementation, control circuitry 304 may place the generated channels as the first channel listings in the media guidance grid.

In another embodiment, control circuitry 304 provides the user with the option to select the placement location of one or more generated channels in the media guidance grid. Control circuitry 304 may display a prompt on display 312 that provides the user with an option to enter one or more channel numbers in which on-demand media assets will be placed. Control circuitry 304 may receive the channel number input from user input interface 310 and accordingly create the one or more channels at the user-specified channel locations.

In some embodiments, control circuitry 304 begins buffering the on-demand media asset when the user is browsing the media guidance grid at a grid location that is a predetermined amount of channels away from the channel in which the media asset identified from the storage device is placed. For example, control circuitry 304 monitors the currently selected media asset listing as the user is browsing media listings in the media guidance grid. Once control circuitry 304 determines that the user is within the predetermined buffering channel pad, control circuitry 304 determines whether the user is scrolling towards the generated media channel. Control circuitry 304 checks to see whether it has received an input from user input interface 310 to select a different media asset listing closer to the generated media asset channel. If control circuitry 304 determines that it has received such an input, control circuitry 304 begins buffering the identified media asset scheduled for current display on the generated media channel. Control circuitry 304 retrieves the identified media asset from the networked storage device once buffering is initiated.

In some embodiments, control circuitry 304 receives on-demand media assets from the media sources without displaying them on display 312 from a reference event. Once control circuitry 304 receives a user selection of an on-demand media listing, control circuitry 304 displays the on-demand media asset received from the media source. Once control circuitry 304 receives a user selection of the on-demand media asset from user input interface 310, control circuitry 304 displays the on-demand media asset on display 312 from a playback location that corresponds to the elapsed time since the reference event.

In another embodiment, control circuitry 304 does not receive an on-demand media asset from the media source or a stored media asset from the networked storage device until the user is within the predetermined buffering channel pad. Once control circuitry 304 determines that the user has selected a media listing within the predetermined buffering channel pad, control circuitry 304 calculates the playback location. Control circuitry 304 adds the elapsed time since the reference event to the start of the on-demand media asset to calculate the playback location. Control circuitry 304 subsequently buffers the on-demand media asset from this calculated playback location once control circuitry 304 determines that the user is browsing media listings within the predetermined buffering channel pad. Once control circuitry 304 receives a user selection of the on-demand media asset, control circuitry 304 displays the on-demand media asset on display 312 from the calculated playback location. Such a feature allows the on-demand media asset to be seamlessly integrated into the media guidance application as a conventionally scheduled broadcast media asset.

The media guidance application may be implemented using any suitable architecture. For example, it may be a stand-alone application wholly implemented on user equipment device 300. In such an approach, instructions of the application are stored locally, and data for use by the application is downloaded on a periodic basis (e.g., from an out-of-band feed, from an Internet resource, or using another suitable approach). In some embodiments, the media guidance application is a client-server based application. Data for use by a thick or thin client implemented on user equipment device 300 is retrieved on-demand by issuing requests to a server remote to the user equipment device 300. In one example of a client-server based guidance application, control circuitry 304 runs a web browser that interprets web pages provided by a remote server.

In some embodiments, the media guidance application is downloaded and interpreted or otherwise run by an interpreter or virtual machine (run by control circuitry 304). In some embodiments, the guidance application may be encoded in the ETV Binary Interchange Format (EBIF), received by control circuitry 304 as part of a suitable feed, and interpreted by a user agent running on control circuitry 304. For example, the guidance application may be an EBIF application. In some embodiments, the guidance application may be defined by a series of JAVA-based files that are received and run by a local virtual machine or other suitable middleware executed by control circuitry 304. In some of such embodiments (e.g., those employing MPEG-2 or other digital media encoding schemes), the guidance application may be, for example, encoded and transmitted in an MPEG-2 object carousel with the MPEG audio and video packets of a program.

User equipment device 300 of FIG. 3 can be implemented in system 400 of FIG. 4 as user television equipment 402, user computer equipment 404, wireless user communications device 406, or any other type of user equipment suitable for accessing content, such as a non-portable gaming machine. For simplicity, these devices may be referred to herein collectively as user equipment or user equipment devices, and may be substantially similar to user equipment devices described above. User equipment devices, on which a media guidance application may be implemented, may function as a stand-alone device or may be part of a network of devices. Various network configurations of devices may be implemented and are discussed in more detail below.

A user equipment device utilizing at least some of the system features described above in connection with FIG. 3 may not be classified solely as user television equipment 402, user computer equipment 404, or a wireless user communications device 406. For example, user television equipment 402 may, like some user computer equipment 404, be Internet-enabled allowing for access to Internet content, while user computer equipment 404 may, like some television equipment 402, include a tuner allowing for access to television programming. The media guidance application may have the same layout on various different types of user equipment or may be tailored to the display capabilities of the user equipment. For example, on user computer equipment 404, the guidance application may be provided as a website accessed by a web browser. In another example, the guidance application may be scaled down for wireless user communications devices 406.

In system 400, there is typically more than one of each type of user equipment device but only one of each is shown in FIG. 4 to avoid overcomplicating the drawing. In addition, each user may utilize more than one type of user equipment device and also more than one of each type of user equipment device.

In some embodiments, a user equipment device (e.g., user television equipment 402, user computer equipment 404, wireless user communications device 406) may be referred to as a “second screen device.” For example, a second screen device may supplement content presented on a first user equipment device. The content presented on the second screen device may be any suitable content that supplements the content presented on the first device. In some embodiments, the second screen device provides an interface for adjusting settings and display preferences of the first device. In some embodiments, the second screen device is configured for interacting with other second screen devices or for interacting with a social network. The second screen device can be located in the same room as the first device, a different room from the first device but in the same house or building, or in a different building from the first device.

The user may also set various settings to maintain consistent media guidance application settings across in-home devices and remote devices. Settings include those described herein, as well as channel and program favorites, programming preferences that the guidance application utilizes to make programming recommendations, display preferences, parental control settings, and other desirable guidance settings. For example, if a user sets a channel as a favorite on, for example, the website www.allrovi.com on their personal computer at their office, the same channel would appear as a favorite on the user's in-home devices (e.g., user television equipment and user computer equipment) as well as the user's mobile devices, if desired. Therefore, changes made on one user equipment device can change the guidance experience on another user equipment device, regardless of whether they are the same or a different type of user equipment device. In addition, the changes made may be based on settings input by a user, as well as user activity monitored by the guidance application.

The user equipment devices may be coupled to communications network 414. Namely, user television equipment 402, user computer equipment 404, and wireless user communications device 406 are coupled to communications network 414 via communications paths 408, 410, and 412, respectively. Communications network 414 may be one or more networks including the Internet, a mobile phone network, mobile voice or data network (e.g., a 4G or LTE network), cable network, public switched telephone network, or other types of communications network or combinations of communications networks. Paths 408, 410, and 412 may separately or together include one or more communications paths, such as, a satellite path, a fiber-optic path, a cable path, a path that supports Internet communications (e.g., IPTV), free-space connections (e.g., for broadcast or other wireless signals), or any other suitable wired or wireless communications path or combination of such paths. Path 412 is drawn with dotted lines to indicate that in the exemplary embodiment shown in FIG. 4 it is a wireless path and paths 408 and 410 are drawn as solid lines to indicate they are wired paths (although these paths may be wireless paths, if desired). Communications with the user equipment devices may be provided by one or more of these communications paths, but are shown as a single path in FIG. 4 to avoid overcomplicating the drawing.

Although communications paths are not drawn between user equipment devices, these devices may communicate directly with each other via communication paths, such as those described above in connection with paths 408, 410, and 412, as well as other short-range point-to-point communication paths, such as USB cables, IEEE 1394 cables, wireless paths (e.g., Bluetooth, infrared, IEEE 802-11x, etc.), or other short-range communication via wired or wireless paths. BLUETOOTH is a certification mark owned by Bluetooth SIG, INC. The user equipment devices may also communicate with each other directly through an indirect path via communications network 414.

System 400 includes content source 416 and media guidance data source 418 coupled to communications network 414 via communication paths 420 and 422, respectively. Paths 420 and 422 may include any of the communication paths described above in connection with paths 408, 410, and 412. Communications with the content source 416 and media guidance data source 418 may be exchanged over one or more communications paths, but are shown as a single path in FIG. 4 to avoid overcomplicating the drawing. In addition, there may be more than one of each of content source 416 and media guidance data source 418, but only one of each is shown in FIG. 4 to avoid overcomplicating the drawing. (The different types of each of these sources are discussed below.) If desired, content source 416 and media guidance data source 418 may be integrated as one source device. Although communications between sources 416 and 418 with user equipment devices 402, 404, and 406 are shown as through communications network 414, in some embodiments, sources 416 and 418 may communicate directly with user equipment devices 402, 404, and 406 via communication paths (not shown) such as those described above in connection with paths 408, 410, and 412.

Content source 416 may include one or more types of content distribution equipment including a television distribution facility, cable system headend, satellite distribution facility, programming sources (e.g., television broadcasters, such as NBC, ABC, HBO, etc.), intermediate distribution facilities and/or servers, Internet providers, on-demand media servers, and other content providers. NBC is a trademark owned by the National Broadcasting Company, Inc., ABC is a trademark owned by the American Broadcasting Company, Inc., and HBO is a trademark owned by the Home Box Office, Inc. Content source 416 may be the originator of content (e.g., a television broadcaster, a Webcast provider, etc.) or may not be the originator of content (e.g., an on-demand content provider, an Internet provider of content of broadcast programs for downloading, etc.). Content source 416 may include cable sources, satellite providers, on-demand providers, Internet providers, over-the-top content providers, or other providers of content. Content source 416 may also include a remote media server used to store different types of content (including video content selected by a user), in a location remote from any of the user equipment devices. Systems and methods for remote storage of content, and providing remotely stored content to user equipment are discussed in greater detail in connection with Ellis et al., U.S. Pat. No. 7,761,892, issued Jul. 20, 2010, which is hereby incorporated by reference herein in its entirety.

Media guidance data source 418 may provide media guidance data, such as the media guidance data described above. Media guidance application data may be provided to the user equipment devices using any suitable approach. In some embodiments, the guidance application may be a stand-alone interactive television program guide that receives program guide data via a data feed (e.g., a continuous feed or trickle feed). Program schedule data and other guidance data may be provided to the user equipment on a television channel sideband, using an in-band digital signal, using an out-of-band digital signal, or by any other suitable data transmission technique. Program schedule data and other media guidance data may be provided to user equipment on multiple analog or digital television channels.

In some embodiments, guidance data from media guidance data source 418 may be provided to users' equipment using a client-server approach. For example, a user equipment device may pull media guidance data from a server, or a server may push media guidance data to a user equipment device. In some embodiments, a guidance application client residing on the user's equipment may initiate sessions with source 418 to obtain guidance data when needed, e.g., when the guidance data is out of date or when the user equipment device receives a request from the user to receive data. Media guidance may be provided to the user equipment with any suitable frequency (e.g., continuously, daily, a user-specified period of time, a system-specified period of time, in response to a request from user equipment, etc.). Media guidance data source 418 may provide user equipment devices 402, 404, and 406 the media guidance application itself or software updates for the media guidance application.

Media guidance applications may be, for example, stand-alone applications implemented on user equipment devices. For example, the media guidance application may be implemented as software or a set of executable instructions which may be stored in storage 308, and executed by control circuitry 304 of a user equipment device 300. In some embodiments, media guidance applications may be client-server applications where only a client application resides on the user equipment device, and server application resides on a remote server. For example, media guidance applications may be implemented partially as a client application on control circuitry 304 of user equipment device 300 and partially on a remote server as a server application (e.g., media guidance data source 418) running on control circuitry of the remote server. When executed by control circuitry of the remote server (such as media guidance data source 418), the media guidance application may instruct the control circuitry 304 to generate the guidance application displays and transmit the generated displays to the user equipment devices. The server application may instruct the control circuitry of the media guidance data source 418 to transmit data for storage on the user equipment. The client application may instruct control circuitry of the receiving user equipment to generate the guidance application displays.

Content and/or media guidance data delivered to user equipment devices 402, 404, and 406 may be over-the-top (OTT) content. OTT content delivery allows Internet-enabled user devices, including any user equipment device described above, to receive content that is transferred over the Internet, including any content described above, in addition to content received over cable or satellite connections. OTT content is delivered via an Internet connection provided by an Internet service provider (ISP), but a third party distributes the content. The ISP may not be responsible for the viewing abilities, copyrights, or redistribution of the content, and may only transfer IP packets provided by the OTT content provider. Examples of OTT content providers include YOUTUBE, NETFLIX, and HULU, which provide audio and video via IP packets. YouTube is a trademark owned by Google Inc., Netflix is a trademark owned by Netflix Inc., and Hulu is a trademark owned by Hulu, LLC. OTT content providers may additionally or alternatively provide media guidance data described above. In addition to content and/or media guidance data, providers of OTT content can distribute media guidance applications (e.g., web-based applications or cloud-based applications), or the content can be displayed by media guidance applications stored on the user equipment device.

Media guidance system 400 is intended to illustrate a number of approaches, or network configurations, by which user equipment devices and sources of content and guidance data may communicate with each other for the purpose of accessing content and providing media guidance. The embodiments described herein may be applied in any one or a subset of these approaches, or in a system employing other approaches for delivering content and providing media guidance. The following four approaches provide specific illustrations of the generalized example of FIG. 4.

In one approach, user equipment devices may communicate with each other within a home network. User equipment devices can communicate with each other directly via short-range point-to-point communication schemes described above, via indirect paths through a hub or other similar device provided on a home network, or via communications network 414. Each of the multiple individuals in a single home may operate different user equipment devices on the home network. As a result, it may be desirable for various media guidance information or settings to be communicated between the different user equipment devices. For example, it may be desirable for users to maintain consistent media guidance application settings on different user equipment devices within a home network, as described in greater detail in Ellis et al., U.S. patent application Ser. No. 11/179,410, filed Jul. 11, 2005. Different types of user equipment devices in a home network may also communicate with each other to transmit content. For example, a user may transmit content from user computer equipment to a portable video player or portable music player.

In a second approach, users may have multiple types of user equipment by which they access content and obtain media guidance. For example, some users may have home networks that are accessed by in-home and mobile devices. Users may control in-home devices via a media guidance application implemented on a remote device. For example, users may access an online media guidance application on a website via a personal computer at their office, or a mobile device such as a PDA or web-enabled mobile telephone. The user may set various settings (e.g., recordings, reminders, or other settings) on the online guidance application to control the user's in-home equipment. The online guide may control the user's equipment directly, or by communicating with a media guidance application on the user's in-home equipment. Various systems and methods for user equipment devices communicating, where the user equipment devices are in locations remote from each other, is discussed in, for example, Ellis et al., U.S. Pat. No. 8,046,801, issued Oct. 25, 2011, which is hereby incorporated by reference herein in its entirety.

In a third approach, users of user equipment devices inside and outside a home can use their media guidance application to communicate directly with content source 416 to access content. Specifically, within a home, users of user television equipment 402 and user computer equipment 404 may access the media guidance application to navigate among and locate desirable content. Users may also access the media guidance application outside of the home using wireless user communications devices 406 to navigate among and locate desirable content.

In a fourth approach, user equipment devices may operate in a cloud computing environment to access cloud services. In a cloud computing environment, various types of computing services for content sharing, storage or distribution (e.g., video sharing sites or social networking sites) are provided by a collection of network-accessible computing and storage resources, referred to as “the cloud.” For example, the cloud can include a collection of server computing devices, which may be located centrally or at distributed locations, that provide cloud-based services to various types of users and devices connected via a network such as the Internet via communications network 414. These cloud resources may include one or more content sources 416 and one or more media guidance data sources 418. In addition or in the alternative, the remote computing sites may include other user equipment devices, such as user television equipment 402, user computer equipment 404, and wireless user communications device 406. For example, the other user equipment devices may provide access to a stored copy of a video or a streamed video. In such embodiments, user equipment devices may operate in a peer-to-peer manner without communicating with a central server.

The cloud provides access to services, such as content storage, content sharing, or social networking services, among other examples, as well as access to any content described above, for user equipment devices. Services can be provided in the cloud through cloud computing service providers, or through other providers of online services. For example, the cloud-based services can include a content storage service, a content sharing site, a social networking site, or other services via which user-sourced content is distributed for viewing by others on connected devices. These cloud-based services may allow a user equipment device to store content to the cloud and to receive content from the cloud rather than storing content locally and accessing locally-stored content.

A user may use various content capture devices, such as camcorders, digital cameras with video mode, audio recorders, mobile phones, and handheld computing devices, to record content. The user can upload content to a content storage service on the cloud either directly, for example, from user computer equipment 404 or wireless user communications device 406 having content capture feature. Alternatively, the user can first transfer the content to a user equipment device, such as user computer equipment 404. The user equipment device storing the content uploads the content to the cloud using a data transmission service on communications network 414. In some embodiments, the user equipment device itself is a cloud resource, and other user equipment devices can access the content directly from the user equipment device on which the user stored the content.

Cloud resources may be accessed by a user equipment device using, for example, a web browser, a media guidance application, a desktop application, a mobile application, and/or any combination of access applications of the same. The user equipment device may be a cloud client that relies on cloud computing for application delivery, or the user equipment device may have some functionality without access to cloud resources. For example, some applications running on the user equipment device may be cloud applications, i.e., applications delivered as a service over the Internet, while other applications may be stored and run on the user equipment device. In some embodiments, a user device may receive content from multiple cloud resources simultaneously. For example, a user device can stream audio from one cloud resource while downloading content from a second cloud resource. Or a user device can download content from multiple cloud resources for more efficient downloading. In some embodiments, user equipment devices can use cloud resources for processing operations such as the processing operations performed by processing circuitry described in relation to FIG. 3.

FIG. 5A and FIG. 5B show components of engagement tracking circuitry 316 used to determine whether the user is paying attention to display 312. Once control circuitry 304 determines that a user is in proximity of user equipment 300, control circuitry 304 can identify the user using engagement tracking circuitry 316. Control circuitry 304 also uses engagement tracking circuitry 316 to determine when the user begins to watch display 312. As mentioned above, this event is a reference event that triggers the reception of on-demand media assets at user equipment 300 from the media source.

FIG. 5A shows an embodiment of eye tracker 500 for identifying the gaze point of a user 508 of user equipment 300. User equipment 300 determines whether the user is watching the display 312 by tracking the gaze of the user. Eye tracker 500 includes processor 502, light source 504, and optical sensor 506. Light source 504 transmits light that reaches at least one eye of a user, and optical sensor 506 is directed at the user to sense reflected light. Optical sensor 506 transmits collected data to processor 502, and based on the data received from optical sensor 506, processor 502 determines a user's gaze point.

Processor 502 may be integrated with one or more light source 504 and one or more optical sensor 506 in a single device. Alternatively, one or more light sources 504 and one or more optical sensors 506 may be housed separately from processor 502 and in wireless or wired communication with processor 502. One or more of processor 502, light source 504, and optical sensor 506 may be integrated into user equipment device 300.

Processor 502 may be similar to processing circuitry 306 described above. In some embodiments, processor 502 may be processing circuitry 306, with processing circuitry 306 in communication with light source 504 and optical sensor 506. In other embodiments, processor 502 may be separate from but optionally in communication with processing circuitry 306.

Light source 504 transmits light to one or both eyes of one or more users. Light source 504 may emit, for example, infrared (IR) light, near infrared light, or visible light. The light emitted by light source 504 may be collimated or non-collimated. The light is reflected in a user's eye, forming, for example, the reflection from the outer surface of the cornea (i.e., the first Purkinje image), the reflection from the inner surface of the cornea (i.e., the second Purkinje image), the reflection from the outer (anterior) surface of the lens (i.e., the third Purkinje image), and/or the reflection from the inner (posterior) surface of the lens (i.e., the fourth Purkinje image).

Optical sensor 506 collects visual information, such as an image or series of images, of one or both of one or more users' eyes. Optical sensor 506 transmits the collected image(s) to processor 502, which processes the received image(s) to identify a glint (i.e., corneal reflection) and/or other reflection in one or both eyes of one or more users. Processor 502 may also determine the location of the center of the pupil of one or both eyes of one or more users. For each eye, processor 502 may compare the location of the pupil to the location of the glint and/or other reflection to estimate the gaze point. Processor 502 may also store or obtain information describing the location of one or more light sources 504 and/or the location of one or more optical sensors 506 relative to display 312. Using this information, processor 502 may determine a user's gaze point on display 312, or processor 502 may determine whether or not a user's gaze point is on display 312.

In particular, processor 502 may identify locations on display 312 using a coordinate system, and processor 502 may identify an (x, y) coordinate representing the user's gaze point on display 312. For example, for a rectangular display, the lower left hand corner may be considered the origin and be assigned the coordinates (0, 0). Moving up display 312, the y-coordinate increases, and moving towards the right on the display, the x-coordinate increases. Any scale for the x and y axes may be used. Alternative coordinate system may be used; for example, the center point of display 312 may be the origin, or any other corner of display 312 may be the origin. The locations of light sources 504 and/or sensors 506 may be identified using this coordinate system. The coordinate system may include a third dimension.

In some embodiments, eye tracker 500 performs best if the position of the user's head is fixed or relatively stable. In other embodiments, eye tracker 500 is configured to account for a user's head movement, which allows the user a more natural viewing experience than if the user's head were fixed in a particular position.

In some embodiments accounting for a user's head movement, eye tracker 500 includes two or more optical sensors 506. For example, two cameras may be arranged to form a stereo vision system for obtaining a 3D position of the user's eye or eyes; this allows processor 502 to compensate for head movement when determining the user's gaze point. The two or more optical sensors 506 may be part of a single unit or may be separate units. For example, user equipment device 300 may include two cameras used as optical sensors 506, or eye tracker 500 in communication with user equipment device 300 may include two optical sensors 506. In other embodiments, each of user equipment device 300 and eye tracker 500 may include an optical sensor, and processor 502 receives image data from the optical sensor of user equipment device 300 and the optical sensor of eye tracker 500. Processor 502 may receive data identifying the location of optical sensors 506 relative to display 312 and/or relative to each other and use this information when determining the gaze point.

In other embodiments accounting for a user's head movement, eye tracker 500 includes two or more light sources for generating multiple glints. For example, two light sources 504 may create glints at different locations of an eye; having information on the two glints allows the processor to determine a 3D position of the user's eye or eyes, allowing processor 502 to compensate for head movement. Processor 502 may also receive data identifying the location of light sources 504 relative to display 312 and/or relative to each other and use this information when determining the gaze point.

In some embodiments, other types of eye trackers that do not utilize a light source may be used. For example, optical sensor 506 and processor 502 may track other features of a user's eye, such as the retinal blood vessels or other features inside or on the surface of the user's eye, and follow these features as the eye rotates. Any other equipment or method for determining one or more users' gaze point(s) not discussed above may be used in addition to or instead of the above-described embodiments of eye tracker 500.

FIG. 5B shows an embodiment of face tracker 550 for identifying the facial position and tilt of a user 558 of user equipment 300 with respect to display 312. User equipment 300 uses face tracker 550 to determine whether user 558 is watching display 312. Face tracker 550 includes processor 552, light source 554, image sensor 506. Light source 554 transmits light that reaches the face of a user, and image sensor 556 and infrared sensor 560 are directed at the user's face to sense reflected light. Image sensor 556 transmits collected data to processor 552, and based on the data received from image sensor 556, processor 552 determines a user's facial position and tilt.

Light source 554 transmits light to the face of the user. Light source 554 may emit, for example, infrared (IR) light, near infrared light, or visible light. The light emitted by light source 554 may be collimated or non-collimated. The light from light source 554 illuminates user's face 558 for image sensor 556 and infrared 556 to capture a clear image of the user's face.

Image sensor 556 and infrared sensor 560 collect visual information, such as an image or series of images, of the user's face. Image sensor 556 and infrared sensor 560 transmit the collected image(s) to processor 552, which processes the received image(s) and implements a facial detection algorithm on the collected image(s). The facial detection algorithm may process the captured image(s) and compare the processed images against a database of previously stored users' faces in storage 308. A database of user profiles associated with the user equipment device 300 may be stored in storage 308. Each user profile in such a database may contain one or more images of the user associated with the user profile. Processor 552 may compare the processed image(s) received from image sensor 556 and infrared sensor 560 against the stored image(s) in the user profile database to identify which user profile corresponds to the detected user. Once the user is identified, control circuitry 304 adds the detected user profile to a list of active user profiles near the user equipment device 300.

Face tracker 550 may use image sensor 556 and infrared sensor 560 in tandem or may use only image sensor 556 or infrared sensor 560.

Processor 502 may also determine the location of a user's face with relation to display 312. Processor 502 may measure the size of the face in the image(s) captured by optical sensor 506 to determine the distance of the user from display 312.

Processor 502 may also determine the tilt and orientation of a user's face with relation to display 312. Processor 502 may process the captured image(s) of a user's face and may execute a facial feature detection algorithm to determine the degree of tilt of a user's face with respect to the optical sensor. Since the optical sensor may be placed near or attached to display 312, the degree of tilt of a user's face from the optical sensor will be the same degree of tilt from display 312. Such an algorithm will detect whether the user is looking straight at display 312 or is looking away from display 312.

Image sensor 556 and infrared sensor 560 may collect a series of images or a video of the user's face. By analyzing the series of images or different video frames captured over a span of time, processor 552 may execute a facial tracking algorithm to determine changes in the position and orientation of face 558 with respect to a display device such as display 312.

In some embodiments accounting for a user's head movement, face tracker 318 includes two or more optical sensors 506. For example, two cameras may be arranged to form a stereo vision system for obtaining a 3D position of the user's face; this allows processor 502 to compensate for head movement when determining the facial position. The two or more optical sensors 506 may be part of a single unit or may be separate units. For example, user equipment device 300 may include two cameras used as optical sensors 506, or face tracker 318 in communication with user equipment device 300 may include two optical sensors 506. In other embodiments, each of user equipment device 300 and face tracker 550 may include an optical sensor, and processor 502 receives image data from the optical sensor of user equipment device 300 and the optical sensor of face tracker 550. Processor 502 may receive data identifying the location of optical sensors 506 relative to display 312 and/or relative to each other and use this information when determining the user's facial position and tilt.

In some embodiments, other types of face trackers that do not utilize a light source may be used. Any other equipment or method for determining a user's facial position and tilt not discussed above may be used in addition to or instead of the above-described embodiments of face tracker 550.

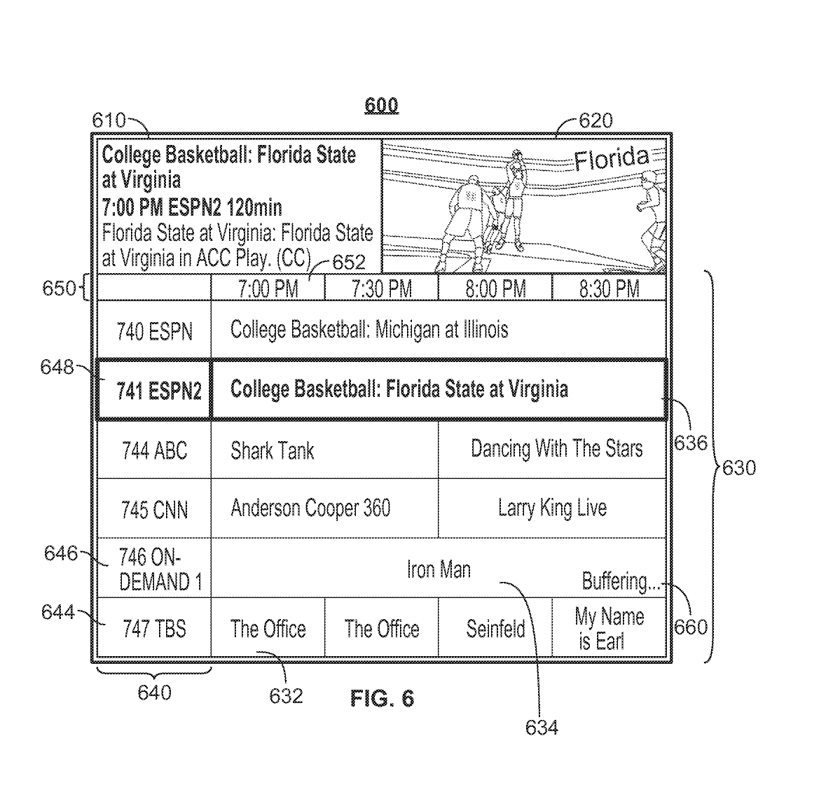

FIG. 6 shows an illustrative interactive media guidance grid display 600 as discussed in the embodiments above. Portions 620 and 630 correspond to portions 122 and 102 of the media guidance application shown in FIG. 1. The interactive media guide listings displayed in such a media guide may be organized by time of broadcast and content provider, similar to grid 102 of FIG. 1. For example, media listing 632 “The Office” is arranged in a grid that corresponds to channel identifier 644 and time identifier 652. The media asset for media listing 632 which airs on ESPN2 at 7:00 PM corresponds to row allocated for channel identifier 644, the row for media assets broadcast on the ESPN2 channel and to the column allocated to time identifier 652, the column for media assets broadcast at 7:00 PM. Certain media assets such as media asset 636, “College Basketball: Florida State at Virginia,” might belong to multiple columns since they might air for a period longer than the minimum time period allocated for a time identifier. Portion 610 displays additional information about a selected media asset. Portion 610 may include a combination of text and graphics.

In the embodiment shown in FIG. 6, the media assets are arranged according to a predetermined order. Row 650 of time identifiers is arranged in order of increasing broadcast time. Similarly, column 640 of channel identifiers is arranged in order of increasing channel numbers.

In the embodiment shown in FIG. 6, the content providers displayed are associated with broadcast channels. Content providers may be non-broadcast channels that contain non-linear programming such as pay-per-view and other VOD channels. Content providers may also provide on-demand media assets from a user library in an online store. Content providers may also include text only channels, recorded content channels, and Internet content channels.

While broadcast media listings are always assigned a broadcast time and a channel number, non-linear media may not always be associated with a broadcast time or a channel number. For instance, certain VOD program listings such as media listing 114 for “HBO On Demand” may only contain a channel identifier (channel number 5 for HBO), the listing may not be associated with a time identifier. Selecting such a VOD listing may allow the user to select one of several VOD programs available from media content source 416. VOD program listings may not be assigned a single time identifier. Instead, they may span the entire row associated with their corresponding channel identifier. In certain other instances, media listing such as Internet content listing 118 may not be assigned a predetermined channel. In one embodiment, control circuitry 304 may assign such media listings a channel number such that all the Internet content listings are assigned channel numbers within a predetermined range of channel numbers (i.e., channels 400-499 may be reserved for Internet content listings). In another embodiment, control circuitry 304 may not assign such non-linear media listings channel numbers. Instead, control circuitry 304 may assign such media listings rows in the interactive media guide such that their channel identifier does not contain a channel number but only a description of the type of non-linear content displayed. Similar techniques may be applied to other non-linear media listings such as recorded content listings like recorded content listing 116.

In the embodiment shown in FIG. 6, media identifier 646 identifies channel 746 as an on-demand channel. Control circuitry 304 has selected the “Iron Man” media asset identified by on-demand listing 634 as the on-demand media asset that matches the user preferences in the user's profile that the user is allowed to access from a media source. In this example, the “Iron Man” media asset is a movie that the user has purchased from BestBuy's Cinemallow online service. The “Iron Man” movie is streamed from BestBuy Cinemallow's servers to user equipment 300. Control circuitry 304 has determined that the user has not watched the “Iron Man” movie at user equipment 300 and that it is the oldest media asset the user has access to that matches the user profile of all of the user's on-demand media assets.

The on-demand media listing for the “Iron Man” movie is generated after control circuitry 304 determines that it is a suitable on-demand media asset to be received at user equipment 300 from BestBuy Cinemallow's servers. In this example, control circuitry 304 determines that the predetermined channel buffer pad is three channels based on user equipment 300's connection with the BestBuy Cinemallow servers. Accordingly, the on-demand channel 746 is placed at a location that is greater than the predetermined channel buffer pad. Additionally, the user may press a button on a remote control or navigate to a settings menu in the media guidance application to allow manual user entry of a channel number where the user desires to place the on-demand channel in the media guidance grid.

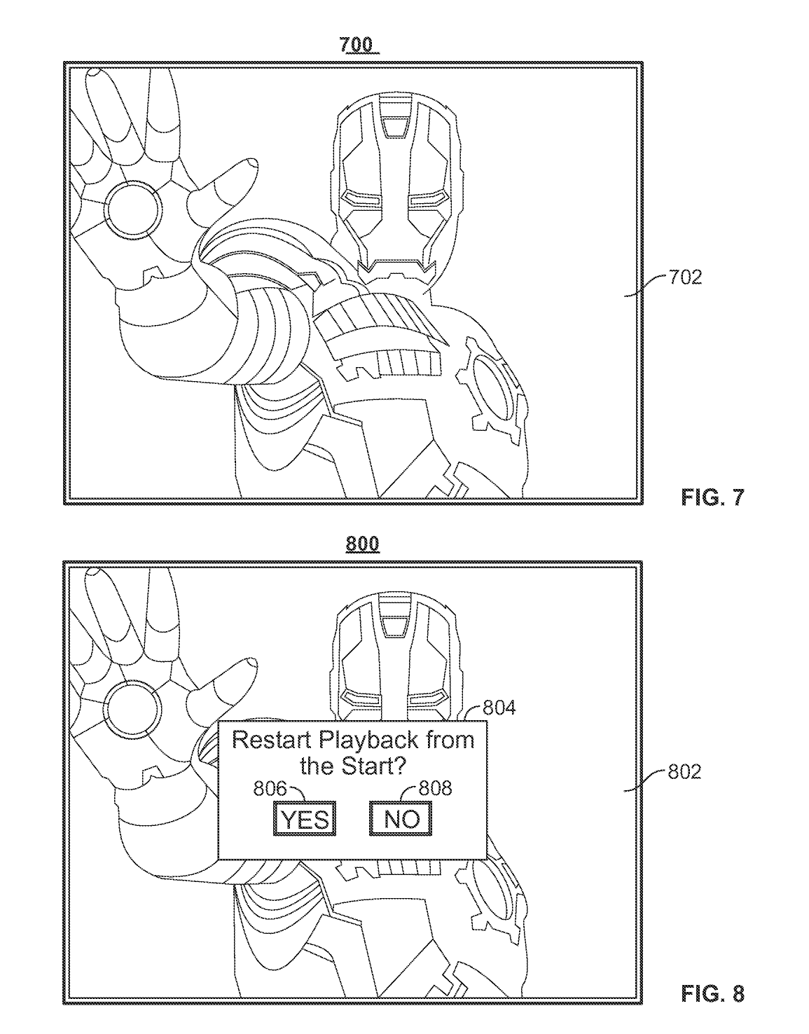

Once the user scrolls through the media guidance grid 600 to select media asset 632, control circuitry 304 determines that the user has selected a media listing within the predetermined channel buffer pad and begins buffering the “Iron Man” movie. Control circuitry 304 may display an indicator 660 on media listing 634 to indicate that media listing 634 is buffering. As soon as control circuitry 304 determines that the user has selected media listing 636, a media listing within the predetermined channel buffer pad, control circuitry 304 calculates the playback location for the “Iron Man” movie. The playback location may be stored in a cache in storage 308. If the user selects the “Iron Man” media listing 634, then control circuitry 304 displays the streaming “Iron Man” media asset received from BestBuy Cinemallow servers on display 312, as shown in FIG. 7.

In some embodiments, control circuitry 304 allows the user to specify in a settings page that the user would prefer to watch the un-edited version of on-demand media assets. For instance, a user can navigate to a settings menu in the interactive media guidance application by pressing a “Menu” button on user input interface 310 to access an interactive media guidance menu that provides the user with the option to specify that the user would like to view unedited version of on-demand media content. Control circuitry 304 will save this preference to the user profile. If control circuitry 304 determines that there are two versions of the same media asset: an edited version and an unedited version, control circuitry 304 will select the unedited version to stream to user equipment 300. Similarly, the user can elect to watch on-demand content without any commercials if he so desires. The user can navigate to a settings menu by pressing a “Menu” button on user input interface 310 to access an interactive media guidance menu that provides the user with the option to specify that the user would like to view unedited version of on-demand media content. Control circuitry 304 will save this preference to the user profile. This will ensure that the BestBuy server does not include any commercials in the on-demand media asset transmitted to user equipment 300.

In another embodiment not shown in FIG. 6, control circuitry 304 may insert the on-demand media asset channel 746 as the user is channel surfing by pressing the up or down keys on his remote control, without browsing media guide grid 600. For instance, control circuitry 304 determines that a detected user has been pressing the channel up button on his remote control for the last thirty seconds. Control circuitry 304 identifies the user using engagement tracking circuitry 316. Control circuitry 304 further determines that the identified user spends an average time of five seconds on each channel before pressing the channel up button again. Control circuitry 304 searches through the list of on-demand media assets that the user has access to that match his user profile. Control circuitry 304 searches through various media sources to create this list of on-demand media assets that the user has access to and that match the viewing preferences set in the identified user's profile. Control circuitry 304 further determines that the “Iron Man” movie has the oldest last accessed date at user equipment 300 of all the on-demand media assets on the list. Accordingly, control circuitry 304 creates an on-demand channel for the “Iron Man” movie.

Control circuitry 304 determines the amount of buffering time required to access the “Iron Man” movie at user equipment 300. For example, control circuitry 304 determines that based on the connection speed between user equipment 300 and the BestBuy Cinemallow servers, it would take 10 seconds of buffering time for the “Iron Man” movie to be received at user equipment 300 from BestBuy's Cinemallow servers. Accordingly, control circuitry 304 determines that the predetermined channel buffer pad is two channels. Control circuitry 304 determines that it will place the on-demand media asset with the “Iron Man” movie on channel 746, which is at least two channels away from the currently viewed channel. Control circuitry 304 may begin buffering the “Iron Man” movie once control circuitry 304 determines that the user is viewing channel 744 which is within the predetermined channel buffer pad. This ensures that the “Iron Man” movie will begin playing without any additional buffering once the user reaches channel 746.

If the user takes a while to reach channel 746, control circuitry 304 may display the “Iron Man” movie from a playback location later than the beginning of the movie. For example, control circuitry 304 may calculate the elapsed time between the time the user turned on display 312 and the time at which the user browsed to channel 746, the on-demand channel. Control circuitry 304 may begin playback of the “Iron Man” movie from a playback location that equals the calculated elapsed time with respect to the beginning of the “Iron Man” movie.

FIG. 7 shows an illustrative display screen displayed on display 312 when the user selects the “Iron Man” on-demand media listing 634 in FIG. 6. Once the user selects on-demand media listing 634, control circuitry 304 displays the video 702 of the “Iron Man” movie on display 312 and plays back audio from the “Iron Man” movie on speakers 314. Playback of the “Iron Man” movie does not necessarily occur from the beginning of the movie. Instead, control circuitry 304 calculates a playback location from which to begin playback of the “Iron Man” movie. Control circuitry 304 adds the elapsed time since a reference event (the time when control circuitry 304 determines that the user begins watching display 312 in this embodiment) to the beginning of the “Iron Man” movie to calculate the playback location of the “Iron Man” movie. Control circuitry 304 displays video 702 on display 312 and plays the audio on speakers 314 from this playback location of the “Iron Man” movie.

In an embodiment, the user may request to restart playback of the “Iron Movie” movie if he so desires. The user may press a button on user input interface 310 to restart playback or to reveal a playback toolbar that allows the user to restart playback of the “Iron Man” movie. Such a playlist toolbar may also allow the user to stop, rewind, fast forward, and pause the “Iron Man” movie.

FIG. 8 shows an illustrative display screen displayed on display 312 when the user selects an option to restart playback of the “Iron Man movie” shown in FIG. 7. Video 802 corresponds to video 702 of the “Iron Man” movie displayed on display 312. Once control circuitry 304 receives a user input from user input interface 310 to restart playback, control circuitry 304 may further instruct the media guidance application running on user equipment 300 to display message 804 on screen 800. Message 804 is a message that prompts the user to restart playback of the “Iron Man” movie. Message 804 may be overlaid on top of the displayed media asset 802 as show in FIG. 8. Alternatively, message 804 may be shown in a non-overlapping region of screen 800 along with the display of the paused media asset 802 on a different region of screen 800. Message 804 may include a “Yes” option 806 and a “No” option 808. User selection of option 806 instructs control circuitry 304 to retrieve and display the “Iron Man” movie from the beginning from BestBuy Cinemallow servers. User selection of option 808 instructs control circuitry 304 to remove the display of message 804.

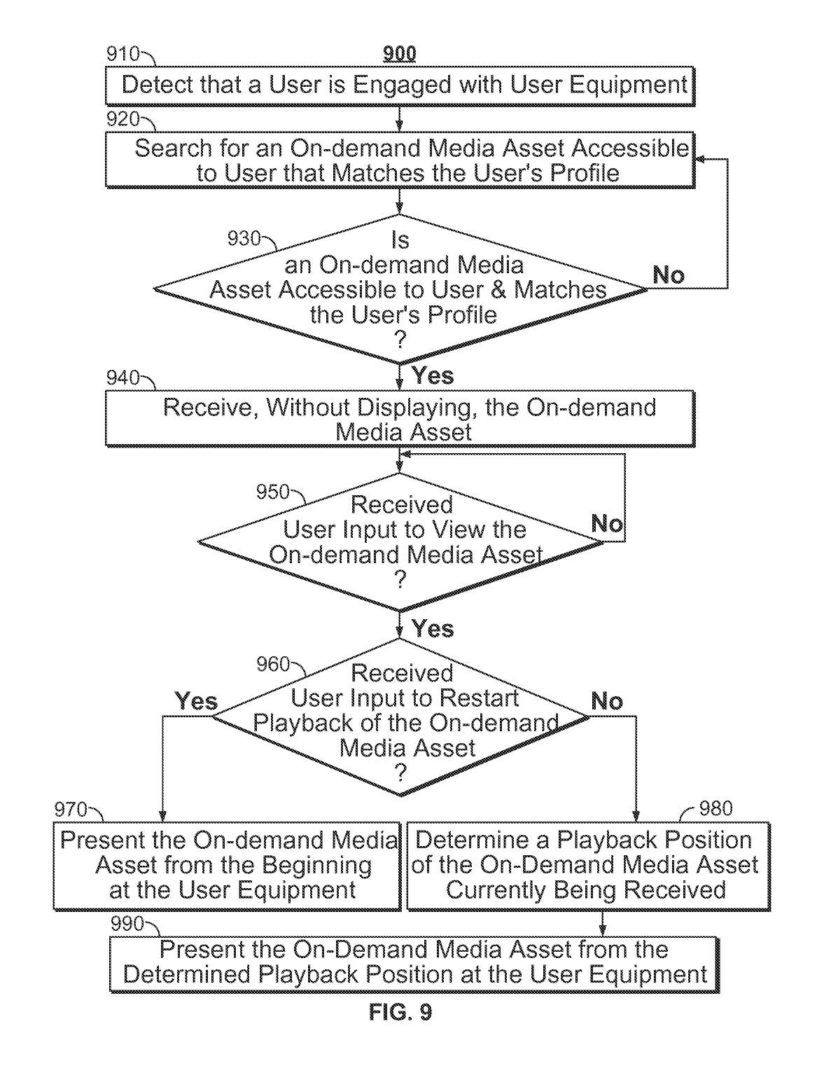

The flow diagrams of FIGS. 9-11 serve to illustrate processes involved in the embodiments described above. Where appropriate, these processes may, for example, be implemented completely in the processing circuitry of a user equipment device (e.g., control circuitry 304 of FIG. 3) or may be implemented at least partially in a remote server. It should be understood that the steps of the flowcharts are merely illustrative and any of the depicted steps may be modified, omitted, or rearranged, two or more of the steps may be combined, or any additional steps may be added, without departing from the scope of the disclosure. Also, some of the steps may be executed or performed substantially simultaneously where appropriate or in parallel to reduce latency and processing times.

At step 910, control circuitry 304 detects that a user is engaged with user equipment 300. For example, control circuitry 304 receives engagement level information from engagement tracking circuitry 316 that indicates that a user is watching display 312. Control circuitry 304 also receives information from engagement tracking circuitry 316 that identifies the user profile of the detected user.

At step 920, control circuitry 304 searches for an on-demand media asset accessible to the user that matches the user's profile. For example, control circuitry 304 may search various media sources to identify an on-demand media asset the user may own or rent that matches the viewing preferences of the user's profile.

At step 930, control circuitry 304 determines whether an identified on-demand media asset from a media source is accessible to the user and it matches the user's profile. If the identified on-demand media asset does not match both criteria, control circuitry 304 searches media sources for another on-demand media asset that satisfies both criteria. In the embodiment depicted in FIG. 6, the “Iron Man” movie is identified to match both criteria.

At step 940, control circuitry 304 receives the identified on-demand media asset from the media source, without displaying it on display 312 in response to determining that the identified on-demand media asset is accessible to the user and that it matches the user's profile. For instance, control circuitry 304 may receive the “Iron Man” movie from BestBuy Cinemallow servers without displaying it at display 312 of user equipment 300.

At step 950, control circuitry 304 determines whether user input is received to view the on-demand media asset. Control circuitry 304 may poll user input interface 310 until such a user input is received.

At step 960, in response to receiving a user input from user input interface 310 to view the on-demand media asset, control circuitry 304 determines whether a user input has been received to restart playback of the on-demand media asset.

At step 970, in response to determining that user input has been received to restart playback of the on-demand media asset, control circuitry 304 presents the on-demand media asset from its beginning at user equipment 300. For example, control circuitry 304 begins to stream the “Iron Man” movie from the beginning from BestBuy Cinemallow's servers.

At step 980, in response to determining that user input is received to restart playback of the on-demand media asset, control circuitry 304 determines a playback position of the on-demand media asset currently being received. For example, control circuitry 304 may determine the current playback location since the on-demand started to be received at the user equipment upon triggering of the reference event.

At step 990, control circuitry 304 presents the on-demand media asset from the determined playback position at the user equipment. For example, control circuitry 304 displays the “Iron Man” movie from the calculated playback position that corresponds to the amount of time that has elapsed since control circuitry 304 detected the reference event.

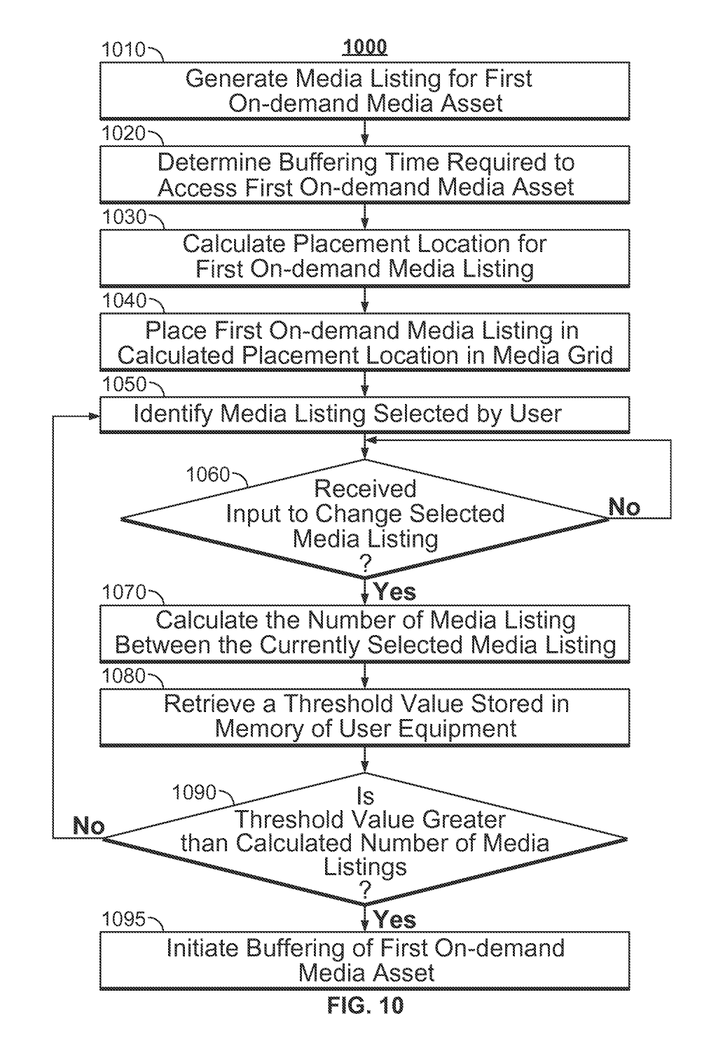

FIG. 10 illustrates a flow diagram containing processes in accordance with an embodiment that describes the process in which an on-demand media listing is generated and placed in the interactive media guidance application.

At step 1010, control circuitry 304 generates a media listing for a first on-demand media asset. For instance, control circuitry 304 creates a media listing for the identified “Iron Man” movie upon determining that the “Iron Man” movie matches the user's profile and is also accessible to the user.

At step 1020, control circuitry 304 determines the buffering time required to access the first on-demand media asset. For example, control circuitry 304 calculates the time required to buffer the “Iron Man” movie based on the connection speed between user equipment 300 and the BestBuy Cinemallow servers.

At step 1030, control circuitry 304 calculates the placement location for the first on-demand media asset. For instance, control circuitry 304 determines the placement location of the “Iron Man” media listing ensuring that the placement location is far enough away from the currently selected media asset to enable enough time to buffer the on-demand media asset.

At step 1040, control circuitry 304 places the first on-demand media listing in the calculated placement location in the media grid.

At step 1050, control circuitry 304 identifies which media listing the user has selected in the media guidance grid.

At step 1060, control circuitry 304 determines whether input has been received to change the selected media listing. For example, control circuitry 304 determines whether a user is scrolling towards the on-demand media asset from the currently selected media listing. Control circuitry 304 polls user input interface 310 until such an input is received from user input interface 310.

At step 1070, control circuitry 304 calculates the number of media listings between the currently selected media listing and the on-demand media listing. Control circuitry 304 determines this value to determine whether the user is browsing a section of the media guidance grid that is close enough to the on-demand listing to begin buffering the on-demand media asset.

At step 1080, control circuitry 304 retrieves a threshold value stored in a memory of user equipment 300. For example, control circuitry 304 identifies the predetermined number of media listings there are in the predetermined channel buffer pad stored in storage 308.

At step 1090, control circuitry 304 determines whether the threshold value is greater than the calculated number of media listings between the currently selected media asset listing and the on-demand media listing. This determines whether the user has selected a media listing that is close enough to the on-demand media listing to begin buffering the on-demand media asset.

At step 1095, in response to determining that the threshold value is indeed greater than the calculated number of media listings between the first on-demand media listing and the currently selected media listing, control circuitry 304 initiates buffering of the first on-demand media asset.

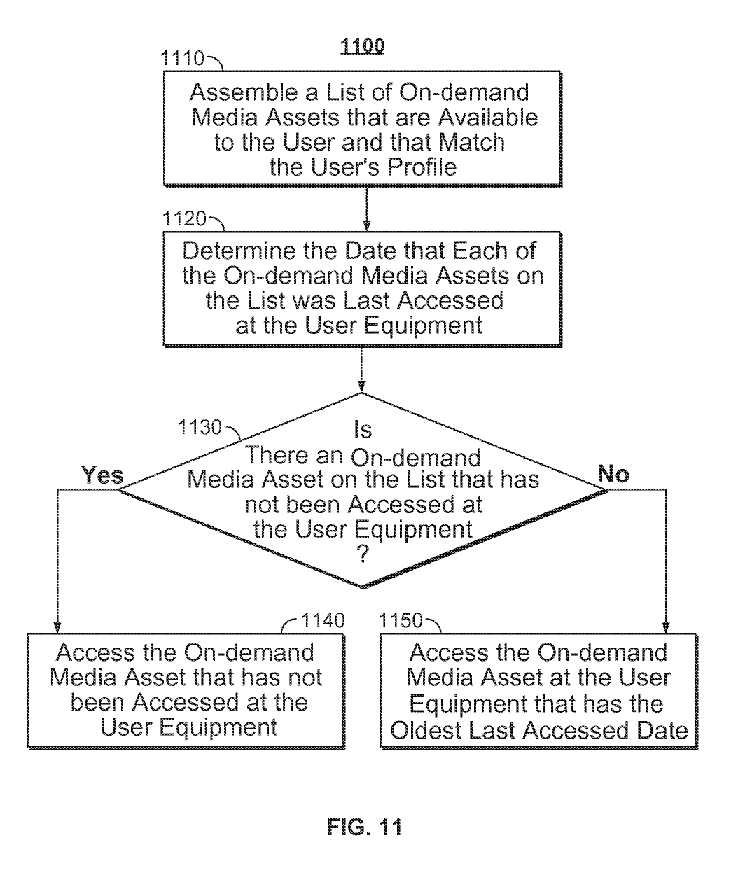

FIG. 11 illustrates a flow diagram containing processes in accordance with an embodiment that describes the process by which an on-demand media asset is selected to ensure that a recently played media asset is not accessed at the user equipment.

At step 1110, control circuitry 304 assembles a list of on-demand media assets that are available to the user and that match the user's profile. Control circuitry 304 may search all available media sources to create such a list of on-demand media assets. Control circuitry 304 may store the list of on-demand media assets in storage 308.

At step 1120, control circuitry 304 determines the date that each of the on-demand media assets on the list was last accessed at user equipment 300. Control circuitry 304 may examine the metadata or other identifiers associated with the media asset to determine the date last accessed at user equipment 300. Alternatively, control circuitry 304 may check the history of assets played back at user equipment 300 to determine the last date that each media asset was accessed.

At step 1130, control circuitry 304 determines whether an on-demand media asset on the list has not been previously accessed at user equipment 300. Control circuitry 304 may examine the metadata or other identifiers associated with the media asset to determine whether the on-demand media asset was ever accessed at user equipment 300. Alternatively, control circuitry 304 may check the history of assets played back at user equipment 300 to determine whether the on-demand media asset was ever accessed at user equipment 300.

At step 1140, control circuitry 304 accesses the on-demand media asset that has not been accessed at user equipment 300 in response to determining that it is an on-demand media asset on the list that not been accessed at user equipment 300. For example, control circuitry 304 receives the identified on-demand media asset that has not been accessed from its media source.

At step 1150, control circuitry 304 accesses the on-demand media asset that has the oldest last accessed date at the user equipment in response to determining that there are no on-demand media assets on the assembled list of on-demand assets that have not been accessed at user equipment 300.

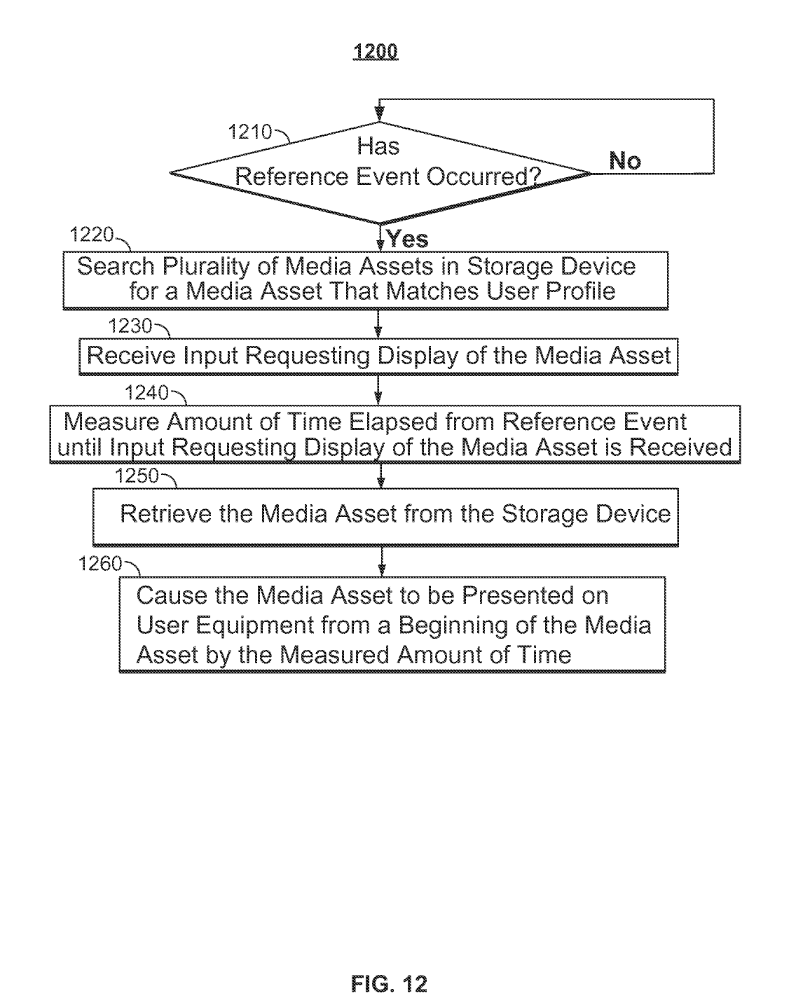

FIG. 12 illustrates a flow diagram containing processes in accordance with an embodiment that describes the process in which a stored media asset is presented on the user equipment.

At step 1210, control circuitry 304 determines whether a reference event has occurred. For example, control circuitry 304 may detect that a user is viewing the user equipment or detect that the user equipment is powered on. Upon detecting such events, control circuitry 304 may determine that a reference event has occurred.

At step 1220, control circuitry 304 searches a plurality of media assets in at least one networked storage device for a stored media asset that matches the user's user profile. For instance, control circuitry 304 may search through the media assets stored on storage devices that are connected to the same wireless network for a media asset that matches the preferences specified in the user profile.

At step 1230, control circuitry 304 receives an input requesting display of the identified media asset. For example, control circuitry 304 may receive a user selection of the media asset listing for the identified media asset. Receipt of such a user input indicates the user's request to display the selected media asset on display 312.

At step 1240, control circuitry 304 measures the amount of time that has elapsed since control circuitry 304 determines that a reference event has occurred until the input requesting display of the media asset is received. For instance, control circuitry 304 may begin a timer once the reference event occurs. Control circuitry 304 may stop the timer once an input requesting display of the media asset is received at user equipment 300.

At step 1250, control circuitry 304 retrieves the media asset from the storage device. For example, control circuitry 304 retrieves the media asset identified in the search from its host storage device. Control circuitry may instruct the storage device to transmit the identified media asset to user equipment 300 over the wireless network.

At step 1260, control circuitry 304 causes the media asset to be presented on user equipment 300 from the beginning of the media asset by the amount of time measured at step 1240. For example, control circuitry 304 may add the amount of elapsed time measured at step 1240 to the beginning of the media asset to determine the playback location from which to present the retrieved media asset on user equipment 300.

The foregoing is merely illustrative of the principles of the systems and methods described herein, and various modifications can be made by those skilled in the art without departing from the scope and spirit of the systems and methods described herein. Furthermore, it should be noted that the features and limitations described in any one embodiment may be applied to any other embodiment herein, and flowcharts or examples relating to one embodiment may be combined with any other embodiment in a suitable manner, done in different orders, or done in parallel. The above-described embodiments are presented for purposes of illustration and not of limitation, and the systems and methods described herein are limited only by the claims which follow.

1-30. (canceled)

31. A method comprising:
determining that a reference event has occurred prior to displaying any of a plurality of media assets available on a streaming source;
responsive to the determination, determining a subset of the plurality of media assets, the subset comprising media assets that a user is allowed to access;
receiving, at user equipment, an input from the user requesting display of a media asset of the subset of media assets;
responsive to the input from the user:
receiving the media asset from the streaming source;
measuring, at user equipment, an amount of time that has elapsed from a time at which the reference event occurred until the input from the user requesting display of the media asset is received;
advancing a playback position of the media asset to a play position that is offset from a beginning of the media asset by the measured amount of time; and
causing the media asset to be presented on the user equipment starting from the play position.

32. The method of claim 31, further comprising generating a media asset listing for the media asset in a media listing grid.

33. The method of claim 31, further comprising:
receiving a user input to restart playback of the media asset from the beginning of the media asset; and
starting playback of the media asset from the beginning of the media asset.

34. The method of claim 31, wherein determining that a reference event has occurred is one of:
detecting that the user is viewing the user equipment; and
detecting that the user equipment is powered on.

35. The method of claim 31, wherein determining the subset of the plurality of media assets comprises:
comparing the plurality of media assets to a criterion associated with media assets, the criterion specifying whether the user is allowed to access a first of the plurality of media assets;
in response to determining a first of the plurality of media assets meets the criterion, adding the first media asset to the subset of the plurality of media assets received from the streaming source; and
in response to determining a second of the plurality of media assets does not meet the criterion, excluding the second media asset from the subset of the plurality of media assets stored on the storage device.

36. The method of claim 31, wherein the media asset received from the streaming source is stored on a storage device, the storage device being located on a same wireless network as the user equipment.

37. The method of claim 31, further comprising:
identifying a second media asset from the determined subset; and
generating a second media asset listing for the second media asset in a media asset listing grid upon identifying the second media asset.

38. The method of claim 31, wherein a media asset listing is generated for the media asset, the method further comprising:
determining an amount of buffer time required to receive the media asset from the streaming source;
calculating a placement location fo the media asset listing in a media listing grid based on the determined buffer time;
placing the media asset listing in the media listing grid at the calculated placement location.

39. The method of claim 31, wherein the media asset is presented on a media asset channel, the method further comprising:
receiving a user input to change a currently selected channel;
calculating the number of channels between the currently selected channel and the media asset channel;
retrieving a threshold value stored in a memory of the user equipment;
determining whether the calculated number of channels is greater than the threshold number; and
initiating buffering of the media asset upon determining that the threshold value is greater than the calculated number of channels.

40. The method of claim 39, wherein the media asset is received from the streaming source once buffering is initiated.

41. A system comprising:
a storage device; and
control circuitry configured to:
determine that a reference event has occurred prior to displaying any of a plurality of media assets available on a streaming source;
responsive to the determination, determine a subset of the plurality of media assets, the subset comprising media assets that a user is allowed to access;
receive, at user equipment, an input from the user requesting display of a media asset of the subset of media assets;
responsive to the input from the user:
receive the media asset from the streaming source and store on the storage device;
measure, at user equipment, an amount of time that has elapsed from a time at which the reference event occurred until the input from the user requesting display of the media asset is received;
advance a playback position of the media asset to a play position that is offset from a beginning of the media asset by the measured amount of time; and
cause the media asset to be presented on the user equipment starting from the play position.

42. The system of claim 41, wherein the control circuitry is further configured to generate a media asset listing for the media asset in a media listing grid.

43. The system of claim 41, wherein the control circuitry is further configured to:
receive a user input to restart playback of the media asset from the beginning of the media asset; and
start playback of the media asset from the beginning of the media asset.

44. The system of claim 41, wherein determining that a reference event has occurred is one of:
detecting that the user is viewing the user equipment; and
detecting that the user equipment is powered on.

45. The system of claim 41, wherein determining the subset of the plurality of media assets comprises:
comparing the plurality of media assets to a criterion associated with media assets, the criterion specifying whether the user is allowed to access a first of the plurality of media assets;
in response to determining a first of the plurality of media assets meets the criterion, adding the first media asset to the subset of the plurality of media assets stored on the storage device; and
in response to determining a second of the plurality of media assets does not meet the criterion, excluding the second media asset from the subset of the plurality of media assets stored on the storage device.

46. The system of claim 41, wherein the storage device is located on a same wireless network as the user equipment.

47. The system of claim 41, wherein the control circuitry is further configured to:
identify a second media asset from the determined subset; and
generate a second media asset listing for the second media asset in a media asset listing grid upon identifying the second media asset.

48. The system of claim 41, wherein a media asset listing is generated for the media asset, the control circuitry being further configured to:
determine an amount of buffer time required to receive the media asset from the streaming source;
calculate a placement location of the media asset listing in a media listing grid based on the determined buffer time;
place the media asset listing in the media listing grid at the calculated placement location.

49. The system of claim 41, wherein the media asset is presented on a media asset channel, the control circuitry being further configured to:
receive a user input to change a currently selected channel;
calculate the number of channels between the currently selected channel and the media asset channel;
retrieve a threshold value stored in a memory of the user equipment;
determine whether the calculated number of channels is greater than the threshold number; and
initiate buffering of the media asset upon determining that the threshold value is greater than the calculated number of channels.

50. The system of claim 49, wherein the media asset is received from the streaming source once buffering is initiated.
